(19) United States
(12) Patent Application Publication
(10) Pub. No.: US 2026/0173997 A1
(43) Pub. Date: Jun. 25, 2026

(54) A SEED TREATMENT COMPOSITION AND METHOD OF USING THE SAME

(71) Applicant: Verdesian Life Sciences U.S., LLC, Cary, NC (US)

(72) Inventors: Dinesh Adhikari, Cary, NC (US); Kuide Qin, Chapel Hill, NC (US); Gary Orr, Pittsboro, NC (US); Rick Riegner, Holly Springs, NC (US)

(21) Appl. No.: 19/127,565

(22) PCT Filed: Nov. 6, 2023
(86) PCT No.: PCT/US2023/036857

§ 371 Date: May 6, 2025

Related U.S. Application Data
(60) Provisional application No. 63/423,867, filed on Nov. 9, 2022.

(51) Int. Cl. A01C 1/06; A01N 25/00; A01N 43/40

(52) U.S. Cl. CPC A01C 1/06; A01N 25/00; A01N 43/40

(57) ABSTRACT

The present disclosure relates to seed compositions for use as seed flow lubricants, wherein the compositions comprise a flour component, a powdered protein component, a dust control additive component, a lubricant additive component, or any combination thereof. Methods of using such seed compositions in agricultural applications are presented herein.

### FIELD

The present disclosure relates to seed compositions for use as seed flow lubricants, wherein the compositions comprise a flour component, a powdered protein component, a dust control component, a lubricant additive component, or any combination thereof. Methods of using such seed compositions in agricultural applications are presented herein.

### BACKGROUND

Seed flow lubricants are materials that are added to the planter box to improve seed flow in the planter. Such lubricants generally are added when the seed is loaded into the planter box, or they may be metered in during planting. Since seed flow lubricants are generally powders, significant airborne lubricant dust can arise during planting. Commonly used seed flow lubricants include talc and graphite, both of which can cause nose, throat, eye, and skin irritation. Further, when graphite and talc are used as seed flow lubricants, they tend to abrade the surfaces of the seeds, creating seed dust. Dust from untreated seeds primarily consists of naturally occurring components of the seed, such as chaff and the seed hull, and dust from treated seeds further comprises components of the seed treatment (e.g., fungicide, insecticide, and the like). The seed dust can become airborne and cause problems to humans, animals, and insects, because the dust include agricultural chemicals generally coating the seeds, which lead to environmental and human safety concerns. The most common and low-cost seed lubricant products are talc and/or graphite-based lubricants. However, the talc/graphite products are known to have human health and environmental risks.

Thus, there is a great need to develop seed flow lubricants that are environmentally friendly and less toxic.

### BRIEF SUMMARY

One aspect of the disclosure is directed to a seed treatment composition comprising a grain flour, a powdered protein, a lubricant additive, and optionally a dust control additive. An exemplary seed treatment composition comprises grain flour present in an amount of from about 40% to about 70% by weight, powdered protein present in an amount of from about 20% to about 50% by weight, and lubricant additive present in an amount of from about 1% to about 10% by weight based on the total weight of the seed treatment composition.

Another aspect of the disclosure relates to a method of reducing the formation of plant seed dust and/or increasing plant seed flowability, the method comprising contacting plant seeds with the seed treatment composition as disclosed herein.

Another aspect of the disclosure relates to a method of making the seed compositions disclosed herein, the method comprising: mixing a grain flour with a powdered protein to afford a homogenous powdered grain flour-protein mixture; contacting the homogenous powdered grain flour-protein mixture with a lubricant additive to coat particles of the homogenous powdered grain flour-protein mixture to afford the seed compositions disclosed herein.

### BRIEF DESCRIPTION OF THE DRAWINGS

FIG. 1 is a graph showing the results of DustView II (Palas GmbH, Karlsruhe, Germany) dust numbers obtained from mixtures of 75 g soybean seed and 1 g lubricant product, wherein the lubricant product can be T&G (a 80:20 talc:graphite mixture), Soy Protein Powder, Wheat Flour, Blend 1, Blend 2, Blend 3, or Blend 4;

FIG. 2A is a graph showing the results of DustView II (Palas GnbH, Karlsruhe, Germany) dust numbers obtained from mixtures of 75 g corn seed and 1 g lubricant product, wherein the lubricant product can be T&G (a 80:20 talc:graphite mixture), Blend 4, Blend 5, or Blend 6;

FIG. 2B is a graph showing the results of DustView II (Palas GmbH, Karlsruhe, Germany) dust numbers obtained from mixtures of 75 g corn seed and 1 g lubricant product, wherein the lubricant product can be T&G (a 80:20 talc:graphite mixture), Blend 8, Blend 9, Blend 10, Blend 11, or Blend 12;

FIG. 3 is a graph showing the results of flowability of soybean seeds from a flow cone treated with different lubricant products such as T&G (a 80:20 talc:graphite mixture), Blend 1, Blend 2, Blend 3, or Blend 4. Product treatment rate was 1 oz/50 lb;

FIG. 4 is a graph showing the results of flowability of soybean seeds from a flow cone treated with different lubricant products such as T&G (a 80:20 talc:graphite mixture), Blend 2, Blend 3, or Blend 4. Product treatment rate was 2 oz/50 lb;

FIG. 5 is a graph showing the results of flowability of corn seeds from a flow cone treated with different lubricant products such as T&G (a 80:20 talc:graphite mixture), Blend 4, Blend 5, or Blend 6. Product treatment rate was 2 oz/50 lb;

FIG. 6 is a graph and pictures showing the results of caking of Blend 7 and the same without lubricant additive product after storing at 95% RH for 24 hours. Pictures A and B are caked and uncaked products of Blend 7. Pictures C and D are caked and uncaked products of Blend 7 without lubricant additive.

FIG. 7A is a graph showing the results of percent target population of corn seeds (large flat) measured in planters using different lubricant products such as T&G (a 80:20 talc:graphite mixture), Blend 2, Blend 3, or Blend 4;

FIG. 7B is a graph showing the results of percent target population of corn seeds (small round) measured in planters using different lubricant products such as T&G (a 80:20 talc:graphite mixture), Blend 2, Blend 3, or Blend 4;

FIG. 8A is a graph showing the results of percent singulation of corn seeds (large flat) measured in planters using different lubricant products such as T&G (a 80:20 talc:graphite mixture), Blend 2, Blend 3, or Blend 4;

FIG. 8B is a graph showing the results of percent singulation of corn seeds (small round) measured in planters, using different lubricant products such as T&G (a 80:20 talc:graphite mixture), Blend 2, Blend 3, or Blend 4;

FIG. 9A is a graph showing the results of percent multi's of corn seeds (large flat) measured in planters using different lubricant products such as T&G (a 80:20 talc:graphite mixture), Blend 2, Blend 3, or Blend 4;

FIG. 9B is a graph showing the results of percent multi's of corn seeds (small round) measured in planters, using different lubricant products such as T&G (a 80:20 talc:graphite mixture), Blend 2, Blend 3, or Blend 4;

FIG. 10A is a graph showing the results of percent skips of corn seeds (large flat) measured in planters using different lubricant products such as T&G (a 80:20 talc:graphite mixture), Blend 2, Blend 3, or Blend 4;

FIG. 10B is a graph showing the results of percent skips of corn seeds (small round) measured in planters, using different lubricant products such as T&G (a 80:20 talc:graphite mixture), Blend 2, Blend 3, or Blend 4;

FIG. 11A is a graph showing the results of percent target population of soybean seeds (2600 seeds/lb) measured in planters using different lubricant products such as T&G (a 80:20 talc:graphite mixture), Blend 2, Blend 3, or Blend 4;

FIG. 11B is a graph showing the results of percent target population of soybean seeds (3000 seeds/lb) measured in planters using different lubricant products such as T&G (a 80:20 talc:graphite mixture), Blend 2, Blend 3, or Blend 4;

FIG. 12A is a graph showing the results of percent singulation of soybean seeds (2600 seeds/lb) measured in planters using different lubricant products such as T&G (a 80:20 talc:graphite mixture), Blend 2, Blend 3, or Blend 4;

FIG. 12B is a graph showing the results of percent singulation of soybean seeds (30(0) seeds/lb) measured in planters, using different lubricant products such as T&G (a 80:20 talc:graphite mixture). Blend 2, Blend 3, or Blend 4;

FIG. 13A is a graph showing the results of percent skips of soybean seeds (2600 seeds/lb) measured in planters using different lubricant products such as T&G (a 80:20 talc:graphite mixture), Blend 2, Blend 3, or Blend 4;

FIG. 13B is a graph showing the results of percent skips of soybean seeds (3000 seeds/4b) measured in planters, using different lubricant products such as T&G (a 80:20 talc:graphite mixture), Blend 2, Blend 3, or Blend 4;

FIG. 14A is a graph showing the results of percent multi's of soybean seeds (2600 seeds/lb) measured in planters using different lubricant products such as T&G (a 80:20 talc:graphite mixture), Blend 2, Blend 3, or Blend 4; and

FIG. 14B is a graph showing the results of percent multi's of soybean seeds (3000 seeds/lb) measured in planters, using different lubricant products such as T&G (a 80:20 talc:graphite mixture), Blend 2, Blend 3, or Blend 4.

### DETAILED DESCRIPTION OF THE INVENTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

Large-scale seed planters typically use vacuum to transfer the crop seeds from planter box (or seed hopper) to each planting furrow row in the ground. This process releases dust from the seed surfaces due to attrition. The dusts released typically include agricultural chemicals that are coated on the seeds, which lead to environmental and human safety concerns. The most common and low-cost lubricant products are talc and/or graphite-based lubricants. However, the talc- and/or graphite-based products are known to have human health and environmental risks. Therefore, there is a need of the seed lubricant products, which release less dust in the environment.

Advantageously, the seed treatment compositions, formulations and methods described herein have shown to provide desirable properties such as: (a) reducing dust emissions during planting compared to talc-containing and non-talc-containing products currently on the market; (b) improving lubrication and minimizing seed-to-seed abrasion thereby ensuring the minimum loss of pesticides from the pre-treated seeds; and/or (c) minimizing human health and environmental impacts compared to traditional talc-based lubricants. Other aspects described herein include seed compositions, formulations, and methods of employing the disclosed seed treatment compositions in planter boxes to reduce the formation of plant seed dust; increase the seed flowability; reduce caking of the seeds and other ingredients; and/or promote overall plant health.

It was unexpectedly discovered that seed lubricant compositions containing a flour component, a powdered protein component and a lubricant additive component as disclosed herein exhibit the various beneficial properties mentioned above. Likewise, it was unexpected and surprising to discover that lubricant composition containing a dust control component and a lubricant additive component as disclosed herein also exhibit several of the beneficial properties mentioned above. Surprisingly, these seed lubricant compositions performed better in the field compared to talc- and/or graphite-based products. This is of particular importance considering that the compositions the majority of components, if not all of the components, are naturally derived ingredients thereby exhibiting more favorable properties towards humans and the environment.

### II. Definitions

Throughout this specification and the claims, the words “comprise,” “comprises.” and “comprising” are used in a nonexclusive sense, except where the context requires otherwise, and is synonymous with “including,” “containing,” or “characterized by,” meaning that it is open-ended and does not exclude additional, unrecited elements or method steps.

As used therein, the transitional phrase “consisting of” excludes any element, step, or ingredient not specified in the claim.

As used herein, the term “about,” when referring to a value is meant to encompass variations of, in some embodiments±5%, in some embodiments±2%, in some embodiments±1%, in some embodiments±0.5%, and in some embodiments±0.1% from the specified amount, as such variations are appropriate to perform the disclosed methods or employ the disclosed compositions.

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed/undecayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal and seaweed extracts. Further examples are enzymatically digested proteins, fish meal, and feather meal. The decomposing crop residue from prior years is another source of fertility. In addition, naturally occurring minerals such as mine rock phosphate, sulfate of potash and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “seed” comprises seed of all types, such as, for example, corns, seeds, fruits, tubers, seedlings, and similar forms. The seed used can be seed of the useful plants mentioned above, but also the seed of transgenic plants or plants obtained by customary breeding methods.

As used herein, the term “pesticide” refers to a substance that is meant to control pests. The term pesticide includes all of the following: insecticides (which may include insect growth regulators, termiticides, etc.), nematicide, molluscicide, piscicide, avicide, bactericide, insect repellent, animal repellent, antimicrobial, and fungicide.

As used herein, the term “insecticide” refers to any substance used to kill insects.

As used herein, the term “larvicide” refers to an insecticide that is specifically targeted against the larval life stage of an insect.

As used herein, the term “bactericide” refers to any substance used to kill bacteria.

As used herein, the term “acaricide” refers to any substance used to kill members of the arachnid subclass Acari, which includes ticks and mites.

As used herein, the term “nematocide” refers to any substance used to kill nematodes.

As used herein, the term “molluscicide” refers to any substance used to kill mollusks.

As used herein, the term “miticide” refers to any substance used to kill mites.

Additional definitions may follow below.

### III. Seed Treatment Composition

The seed treatment composition disclosed herein comprises a flour component, a powdered protein component, a dust control additive component, a lubricant additive component, or combinations thereof. In some embodiments, the seed treatment composition comprises a flour component, a powdered protein component, and a lubricant additive component. In some embodiments, the seed treatment composition disclosed herein comprises a dust control additive component and a lubricant additive component (e.g., a fatty acid and/or a synthetic wax). In some embodiments, the composition disclosed herein comprises a grain flour, a powdered protein, and a lubricant additive, and optionally a dust control additive component. In some embodiments, the optionally dust control additive component is present. In some embodiments, the dust control additive component is absent. In some embodiments, the seed treatment composition disclosed herein comprises a flour component, a powdered protein component, a dust control additive component, and a lubricant additive component and may further comprise a dust control additive component. It was surprising and unexpected to discover that the disclosed seed treatment compositions exhibited the following benefits: (a) minimization of human health and environmental impacts compared to traditional tale-based lubricants; (b) reduced dust emissions during planting compared to talc-containing and non-talc-containing products currently on the market; and (c) improves lubrication and minimizes seed-to-seed abrasion thereby ensures the minimum loss of pesticides from the pre-treated seeds.

The amount of each component present in the seed treatment compositions disclosed herein can vary. In some embodiments, the flour component and powdered protein component are present in the seed treatment composition at a weight ratio of from about 1:100 to about 100:1, about 1:75 to about 75:1, about 1:50 to about 50:1, about 1:25 to about 25:1, about 1:20 to about 20:1, about 1:15 to about 15:1, about 1:10 to about 10:1, about 1:8 to about 8:1, about 1:5 to about 5:1, about 1:3 to about 3:1, about 1:2 to about 2:1, or about 1:1.

In some embodiments, the lubricant additive component and the flour component or powdered protein component as disclosed herein are present in the seed treatment composition at a weight ratio from about 1:100 to about 1:75, from about 1:75 to about 1:50, from about 1:50 to about 1:25, from about 1:25 to about 1:15, or from about 1:15 to about 1:5. In some embodiments the flour component or powdered protein component and the lubricant additive component as disclosed herein are present in the seed treatment composition at a weight ratio from about 1:75 to about 1:4, from about 1:50 to about 1:4, from about 1:25 to about 1:4, from about 1:13 to about 1:4, from about 1:12 to about 1:4, from about 1:11 to about 1:4, from about 1:10 to about 1:4, from about 1:9 to about 1:4, from about 1:8 to about 1:4, from about 1:7 to about 1:4, or from about 1:6 to about 1:4.

In some embodiments, the lubricant additive component and the dust control additive component as disclosed herein are present in the seed treatment composition at a weight ratio from about 1:100 to about 100:1, about 1:75 to about 75:1, about 1:50 to about 50:1, about 1:25 to about 25:1, about 1:20 to about 20:1, about 1:15 to about 15:1, about 1:10 to about 10:1, about 1:8 to about 8:1, about 1:5 to about 5:1, about 1:3 to about 3:1, about 1:2 to about 2:1, or 1:1 In some embodiments, the seed treatment compositions disclosed herein does not include talc. In another embodiment, the seed treatment composition disclosed herein does not include graphite or graphite blends. In yet another embodiment, the seed treatment composition disclosed herein is talc and/or graphite free, i.e., the seed treatment composition does not include blends of graphite and/or talc. In another embodiment, the seed treatment composition disclosed herein contains trace amounts of talc or graphite (i.e., an amount less than 0.1% by weight based on the total weight of the seed treatment composition). In another embodiment, the seed treatment composition disclosed herein contains less than about 0.5%, less than about 1%, less than about 5%, less than about 10%, less than about 20%, less than about 20%, less than about 30%, less than about 40%, or less than about 50% by weight of talc, graphite, or a combination of talc or graphite, based on the total weight of the seed treatment composition.

### A. Flour Component

The flour component comprised in the seed treatment composition disclosed herein can be derived from grains, legumes, nuts, vegetables, or a combination thereof.

In some embodiments, the flour component comprises/consist of a grain flour derived from grains. Exemplary grain flours include, but is not limited to, amaranth flour, barley flour, rice flour, buckwheat flour, corn flour, millet flour, quinoa flour, rye flour, spelt flour, wheat flour, sorghum flour, oat flour, einkorn flour, emmer flour, khorasan flour, and any combination thereof. In some embodiments, the grain flour is selected from the group consisting of wheat flour, corn flour, rice flour, barley flour, oat flour, and any combination thereof. In some embodiments, the grain flour is wheat flour.

In some embodiments, the flour component comprises/consist of a legume flour derived from legumes. Exemplary legumes include, but are not limited to, chickpeas, peanuts, soybeans, lentils, beans, peas, or any combination thereof. In some embodiments, legumes from which legume flour is derived from include, but are not limited to, black beans, pinto beans, appaloosa beans, scarlet runner beans, red beans, rattlesnake beans, pink beans, anasazi beans, adzuki beans, fava beans, eye of the goat beans, green lentils, puy lentils, crimson lentils, Castelluccio lentils, brown lentils, Beluga lentils, red Lentils, red split lentils, ivory lentils, yellow lentils, flageolets beans, pigeon peas, black calypso beans, bolita beans, cannellini beans, Christmas lima beans, cranberry beans, snap beans, green peas, yellow split peas, pigeon split peas, green split peas, lima peas, kidney peas, black-eyed peas, navy beans, great northern beans, pinto beans, yellow peas, desi chickpeas and combinations thereof. Additional examples of legume flour include, but are not limited to, chickpea flour, green pea flour, red lentils flour, rice flour, pinto bean flour, mung bean flour, fava bean flour, garfava flour, white bean flour, yellow pea flour, or any combination thereof.

In some embodiments, the flour component comprises/consist of a nut flour derived from nuts. Exemplary nuts include, but are not limited to, almond, chestnut, hazelnut, cashew, macadamia, pecans, tiger nut, walnut, pistachio, or a combination thereof.

In some embodiments, the flour component comprises/consist of a vegetable flour derived from vegetables. Exemplary vegetable include, but are not limited to, beets, beetroot, carrot, broccoli, spinach, green peas, kale flour, yarn, potato or a combination thereof.

In some embodiments, the flour component comprises/consists of wheat four, potato flour, maize (corn) flour, rice flour, barley flour, oat flour, or a combination thereof.

The amount of flour component present in the seed treatment composition can vary depending on the source of flour and a skilled artisan would be aware of that and adjust the amount accordingly. In some embodiments, the amount of the flour component present in the seed treatment composition is from about 0.1% to about 99%, from about 1% to about 90% from about 10% to about 80%, from about 15% to about 75%, from about 20% to about 70%, from about 25% to about 65%, from about 35% to about 65%, from about 45% to about 65%, from about 45% to about 63%, or from about 45% to about 50% weight based on the total weight of the seed treatment composition. In some embodiments, the amount of flour component present in the seed treatment composition is from about 1% to about 75%, from about 25% to about 70%, from about 30% to about 70%, from about 40% to about 70%, from about 45% to about 65%, from about 47% to about 65%, or from about 47% to about 63% by weight based on the total weight of the seed treatment composition. In some embodiments, the amount of flour component present in the seed treatment composition is less than about 99%, about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, or less than about 5% by weight based on the total weight of the seed treatment composition.

### B. Powdered Protein Component

The powdered protein component comprised in the seed treatment composition disclosed herein is derived from plant and/or non-plant sources.

The seed treatment compositions disclosed herein comprise a powdered protein component. A variety of powdered proteins are suitable for use in the seed treatment composition. In some embodiments, the powdered protein component comprises one or more powdered proteins obtained from plant proteins, animal proteins, fungal proteins, a bacterial proteins, or a combination thereof.

In some embodiments, the powdered protein component comprises/consists of a plant protein. Non-limiting examples of suitable plant proteins include, but are not limited to, soy protein, corn protein, oat protein, wheat protein, pea protein, rice protein, nut protein, algal (e.g., Spirulina) protein, or kelp protein.

In some embodiments, the powdered protein component comprises/consists of a plant protein derived from legumes, grains, nuts, nightshades, seeds, squashes, or any combination thereof.

In some embodiments, the powdered protein component comprises/consists of a powdered protein powder derived from legumes. Exemplary legumes include, but are not limited to, beans (e.g., cacao beans), chickpeas, lentils, peas, soy, or any combination thereof. In some embodiments, the powdered protein component comprises soy protein powder.

In some embodiments, the powdered protein component comprises/consists of a protein powder derived from grains. Exemplary grains include, are not limited to, whole grains, barley, wheat, buckwheat, quinoa, kamut, rye, spelt, wheat, oats, rice, bulgur, corn, or a combination thereof.

In some embodiments, the powdered protein component comprises/consists of a powdered protein derived from nightshades. Exemplary nightshades include but are not limited to potatoes, peppers (e.g., bell and hot peppers including jalapenos) eggplants, goji berries, tomatoes, or a combination thereof.

In some embodiments, powdered protein component comprises/consists of a powdered protein derived from nuts. Exemplary nuts include, but are not limited to, peanuts, almonds, pine nuts, hazelnuts, cashews, or a combination thereof.

In some embodiments, the powdered protein component comprises/consists of a powdered protein derived from seeds. Exemplary seeds include, but are not limited to, sunflower, rapeseed, sesame, cottonseed, wheat germ, or a combination thereof.

In some embodiments, the powdered protein component comprises/consist of a powdered protein derived from squash. Exemplary squash include, but are not limited to, pumpkin, acorn squash, butternut squash, zucchini, or a combination thereof.

In some embodiments, the powdered protein component comprises/consists of an animal protein. In some embodiments, the powdered protein component is derived from eggs, poultry meat, cattle meat, or a combination thereof. Examples of suitable animal proteins include, but are not limited to, whey protein, casein protein, egg protein, albumen protein, blood meal protein, bone meal protein, fish protein, shellfish protein, or plankton protein.

In some embodiments, the powdered protein component comprises/consists of a fungal protein chosen from brewer's yeast protein (i.e., Saccharomyces cerevisiae) or a probiotic yeast protein (e.g., Saccharomyces cerevisiae, Saccharomyces boulardii, or Kluyveromyces lactis).

In some embodiments, the powdered protein component comprises/consists of bacterial protein. For example, the bacterial protein may be derived from probiotic bacteria such as Lactobacillus, Bifidobacterium, or Bacillus.

In some embodiments, the powdered protein comprises/consists of a protein powder derived from sunflower, soy, corn, peanuts, grains, eggs, or a combination thereof. In some embodiments, the powdered protein comprises soybean powder after oil extraction. In some embodiments, the powdered protein component is soy protein powder.

The amount of powdered protein component present in the seed treatment composition can vary depending on the source of the powdered protein and a skilled artisan would be aware of that and adjust the amount accordingly. In some embodiments, the amount powdered protein component present in the seed treatment composition is from about 0.1% to about 99%, from about 1% to about 95% from about 10% to about 85%, from about 15% to about 80%, from about 20% to about 75%, from about 25% to about 70%, from about 30% to about 65%, from about 35% to about 60, from about 40% to about 55% weight based on the total weight of the seed treatment composition. In some embodiments, the amount of powdered protein component present in the seed treatment composition is from about 1% to about 75%, from about 5% to about 70%, from about 10% to about 65%, from about 15% to about 60%, from about 20% to about 55%, from about 20% to about 50%, from about 30% to about 50%, from about 40% to about 50%, or from about 45% to about 50% by weight based on the total weight of the seed composition. In some embodiments, the amount of powdered protein present in the seed treatment composition is less than about 99%, about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, or less than about 5% by weight based on the total weight of the seed treatment composition.

### C. Dust Control Additive Component

The dust control additive component present in the seed treatment compositions disclosed herein is a polyanionic polymer. The polyanionic polymer can be naturally derived (i.e., can be found in nature) or can be prepared synthetically. Exemplary naturally derived polyanionic polymers include, but are not limited to alginic acid (which is found in brown algae) and salts thereof (e.g., sodium alginate) and guar gum (which is extracted from guar beans). Exemplary synthetically prepared polyanionic polymer are polymers comprising a copolymer containing two or more different repeat units. As used herein, “copolymer” refers to a polymer having at least two different monomers or repeat units, and thus encompasses terpolymers, tetrapolymers, and higher order polymers. These different types of copolymers are discussed separately below as “Polymer I” and “Polymer II.”

### Polymer I

Broadly speaking, the Polymer I compositions disclosed herein are in the form of copolymers containing at least two of maleic, itaconic, and sulfonate moieties or repeat units, although such copolymers may also contain other repeat units, such as different dicarboxylates and/or sulfonates. Specific examples of Polymer I copolymers are set forth below as Class I, Class II, and Class IIA copolymers. These copolymers are usually employed in partial salt form in aqueous dispersion or solution, at pH levels of from about 0.5-8, more preferably from about 3.5-6.5.

### Class I Copolymers Containing Maleic and Itaconic Repeat Units

Broadly speaking, the polyanionic copolymers of this class are of the type disclosed in U.S. Pat. No. 8,043,995, which is incorporated by reference herein in its entirety. The copolymers include both maleic and itaconic repeat units, and, if desired, other repeat units such as the B and C repeat units described below. All of the repeat units may be randomly distributed throughout the copolymer chains.

In detail, repeat unit B is inclusive of maleic repeat units, but is broader and is of the general formula or

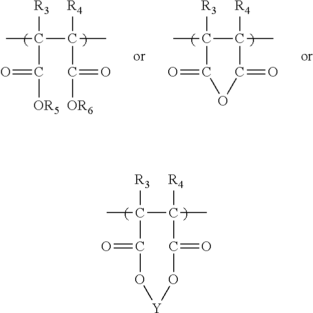

and repeat unit C is inclusive of itaconic repeat units, but is broader and is of the general formula

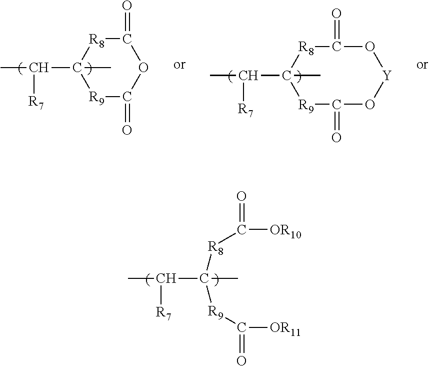

wherein each R₇ is individually and respectively selected from the group consisting of H, OH, C₁-C₃₀ straight, branched chain and cyclic alkyl or aryl groups, C₁-C₃₀ straight, branched chain and cyclic alkyl or aryl formate (C₀), acetate (C₁), propionate (C₂), butyrate (C₃), etc. up to C₃₀ based ester groups, R′CO₂ groups, OR′ groups and COOX groups, wherein R′ is selected from the group consisting of C₁-C₃₀ straight, branched chain and cyclic alkyl or aryl groups and X is selected from the group consisting of H, the alkali metals, NH₄ and the C₁-C₄ alkyl ammonium groups, R₃ and R₄ are individually and respectively selected from the group consisting of H, C₁-C₃₀ straight, branched chain and cyclic alkyl or aryl groups, R₅, R₆, R₁₀ and R₁₁ are individually and respectively selected from the group consisting of H, the alkali metals, NH₄ and the C₁-C₄ alkyl ammonium groups, Y is selected from the group consisting of Fe, Mn, Mg, Zn, Cu, Ni, Co, Mo, V, W, the alkali metals, the alkaline earth metals, polyatomic cations containing any of the foregoing (e.g., VO⁺²), amines, and mixtures thereof; and R₈ and R₉ are individually and respectively selected from the group consisting of nothing (i.e., the groups are non-existent), CH₂, C₂H₄, and C₃H₆.

As can be appreciated, the Class I copolymers typically have different types and sequences of repeat units. For example, a Class I copolymer comprising B and C repeat units may include all three forms of B repeat units and all three forms of C repeat units, so long as the copolymers contain maleic and itaconic repeat units. In the case of the Class I copolymers made up principally of B and C repeat units, R₅, R₆, R₁₀, and R₁₁ are individually and respectively selected from the group consisting of H, the alkali metals, NH₄, and the C₁-C₄ alkyl ammonium groups.

The Class I copolymers may have a wide range of repeat unit concentrations. For example, Class I copolymers having varying ratios of B:C (e.g., 10:90, 60:40, 50:50, 40:60, and 90:10) are contemplated and embraced by the present invention. Such copolymers would be produced by varying monomer amounts in the reaction mixture from which the final product is eventually produced and the B and C type repeat units may be arranged in the copolymer backbone in random order or in an alternating pattern. The foregoing B:C ratios also apply to the preferred Class I copolymers consisting essentially or entirely of maleic and itaconic repeat units.

The Class I copolymers may also have a wide variety of molecular weights, ranging for example from 500-5,000,000 Da, but more usually have a molecular weight of from about 2,000-15,000 Da, and more preferably from about 2,500-10,000 Da.

Preferred Class I copolymers are usually synthesized using dicarboxylic acid monomers, as well as precursors and derivatives thereof. For example, copolymers containing mono and dicarboxylic acid repeat units with vinyl ester repeat units and vinyl alcohol repeat units are contemplated; however, copolymers principally comprised of dicarboxylic acid repeat units are preferred (e.g., at least about 85%, and more preferably at least about 93%, of the repeat units are of this character).

Class I copolymers may be readily complexed with salt-forming cations using conventional methods and reactants. Usable cations can be simple cations such as sodium, but more complex cations can also be used, such as cations containing a metal atom and other atom(s) as well, e.g., vanadyl cations. Among preferred metal cations are those derived from alkali, alkaline earth, and transition metals. The cations may also be amines (as used herein, “amines” refers to primary, secondary, or tertiary amines, monoamines, diamines, and triamines, as well as ammonia, ammonium ions, quaternary amines, quaternary ammonium ions, alkanolamines (e.g., ethanolamine, diethanolamine, and triethanolamine), and tetraalkylammonium species). The most preferred class of amines are alkyl amines, where the alkyl group(s) have from 1-30 carbon atoms and are of straight or branched chain configuration. Such amines should be essentially free of aromatic rings (no more than about 5 mole percent aromatic rings, and more preferably no more than about 1 mole percent thereof). A particularly suitable alkyl amine is isopropylamine. These possible secondary cations should be reacted with no more than about 10 mole percent of the repeat units of the copolymer.

### Class II Copolymers Containing Sulfonate Repeat Units

The Class II polyanionic copolymers disclosed herein also contain either maleic or itaconic repeat units (or both), and sulfonate repeat units, and are at least tetrapolymers, i.e., they are composed of at least four different repeat units. These copolymers thus may include, in addition to the maleic and/or itaconic repeat units and sulfonate repeat units, extra repeat units selected from the group consisting of type B′, type C′, and type G repeat units, and mixtures thereof. However, the Class II copolymers comprehend copolymers having more than four distinct repeat units, with the excess repeat units being selected from the group consisting of type B′, type C′, and type G repeat units, and mixtures thereof, as well as other monomers or repeat units not being type B′, C′, or G repeat units. Class II copolymers are described in WO 2015/031521, incorporated by reference herein in its entirety.

Preferred Class II copolymers contain at least one repeat unit from the B′ or C′ repeat units, and at least one G type repeat unit. Particularly preferred copolymers comprise a single type B′ repeat unit, a single type C′ repeat unit, and two different type G repeat units, or two different type B′ repeat units, a single type C′ repeat unit, and one or more different type G repeat units.

However constituted, preferred Class II copolymers contain at least about 90 mole percent (more preferably at least about 96 mole percent) of repeat units selected from the group consisting of type B′, C′, and G repeat units (i.e., the copolymers should contain no more than about 10 mole percent (preferably no more than about 4 mole percent) of repeat units not selected from types B′, C′, and G).

The Class II copolymers are easily converted to partial or fully saturated salts by a simple reaction with an appropriate salt-forming cation compound, and the types of usable cations are the same as those described above in connection with Class I copolymers.

### 1. Type B′ Repeat Units

Type B′ repeat units are inclusive of maleic repeat units, but more broadly are characterized as dicarboxylate repeat units derived from monomers of maleic acid and/or anhydride, fumaric acid and/or anhydride, mesaconic acid and/or anhydride, substituted maleic acid and/or anhydride, substituted fumaric acid and/or anhydride, substituted mesaconic acid and/or anhydride, mixtures of the foregoing, and any isomers, esters, acid chlorides, and partial or complete salts of any of the foregoing. As used herein with respect to the type B′ repeat units, “substituted” species refers to alkyl substituents (preferably C1-C6 straight or branched chain alkyl groups substantially free of ring structures), and halo substituents (i.e., no more than about 5 mole percent of either ring structures or halo substituents, preferably no more than about 1 mole percent of either); the substituents are normally bound to one of the carbons of a carbon-carbon double bond of the monomer(s) employed. In preferred forms, the total amount of type B′ repeat units in the Class II copolymers of the invention should range from about 1-70 mole percent, more preferably from about 20-65 mole percent, and most preferably from about 35-55 mole percent, where the total amount of all of the repeat units in the Class II copolymer is taken as 100 mole percent.

Maleic acid, methylmaleic acid, maleic anhydride, methylmaleic anhydride, and mesaconic acid (either alone or as various mixtures) are the most preferred monomers for generation of type B′ repeat units. Those skilled in the art will appreciate the usefulness of in situ conversion of acid anhydrides to acids in a reaction vessel just before or even during a reaction. However, it is also understood that when corresponding esters (e.g., maleic or citraconic esters) are used as monomers during the initial polymerization, this should be followed by hydrolysis (acid or base) of pendant ester groups to generate a final carboxylated copolymer substantially free of ester groups.

### 2. Type C′ Repeat Units

Type C′ repeat units are inclusive of itaconic repeat units, but more broadly are characterized as derived from monomers of itaconic acid and/or anhydride, substituted itaconic acid and/or anhydride, as well as isomers, esters, acid chlorides, and partial or complete salts of any of the foregoing. The type C′ repeat units are present in the preferred Class II copolymers of the invention at a level of from about 1-80 mole percent, more preferably from about 15-75 mole percent, and most preferably from about 20-55 mole percent, where the total amount of all of the repeat units in the copolymer is taken as 100 mole percent.

The itaconic acid monomer used to form type C′ repeat unit has one carboxyl group, which is not directly attached to the unsaturated carbon-carbon double bond used in the polymerization of the monomer. Hence, the preferred type C′ repeat unit has one carboxyl group directly bound to the copolymer backbone, and another carboxyl group spaced by a carbon atom from the copolymer backbone. The definitions and discussion relating to “substituted,” “salt,” and useful salt-forming cations (metals, amines, and mixtures thereof) with respect to the type C′ repeat units, are the same as those set forth for the type B′ repeat units.

Unsubstituted itaconic acid and itaconic anhydride, either alone or in various mixtures, are the most preferred monomers for generation of type C′ repeat units. Again, if itaconic anhydride is used as a starting monomer, it is normally useful to convert the itaconic anhydride monomer to the acid form in a reaction vessel just before or even during the polymerization reaction. Any remaining ester groups in the copolymer are normally hydrolyzed, so that the final carboxylated copolymer is substantially free of ester groups.

### 3. Type G Repeat Units

Type G repeat units are derived from substituted or unsubstituted sulfonate-bearing monomers possessing at least one carbon-carbon double bond and at least one sulfonate group, in acid, partial or complete salt, or other form, and which are substantially free of aromatic rings and amide groups (i.e., no more than about 5 mole percent of either aromatic rings or amide groups, preferably no more than about 1 mole percent of either). The type G repeat units are preferably selected from the group consisting of C1-C8 straight or branched chain alkenyl sulfonates, substituted forms thereof, and any isomers or salts of any of the foregoing; especially preferred are alkenyl sulfonates selected from the group consisting of vinyl, allyl, and methallylsulfonic acids or salts. The total amount of type G repeat units in the Class II copolymers of the invention should range from about 0.1-65 mole percent, more preferably from about 1-35 mole percent, and most preferably from about 1-25 mole percent, where the total amount of all of the repeat units in the Class II copolymer is taken as 100 mole percent. The definitions and discussion relating to “substituted,” “salt,” and useful salt-forming cations (metals, amines, and mixtures thereof) with respect to the type G repeat units, are the same as those set forth for the type B′ repeat units.

Vinylsulfonic acid, allylsulfonic acid, and methallylsulfonic acid, either alone or in various mixtures, are deemed to be the most preferred monomers for generation of type G repeat units. It has also been found that alkali metal salts of these acids are also highly useful as monomers. In this connection, it was unexpectedly discovered that during polymerization reactions yielding the novel copolymers of the invention, the presence of mixtures of alkali metal salts of these monomers with acid forms thereof does not inhibit completion of the polymerization reaction.

One preferred Class II copolymer is a partial sodium salt having a pH of about 1, with a repeat unit molar composition of maleic 45 mole percent, itaconic 50 mole percent, methallylsulfonic 4 mole percent, and allylsulfonic 1 mole percent. This specific copolymer is referred to as the “T5” copolymer.

### Class II Copolymers

Class IIA copolymers contain both dicarboxylate and sulfonate functional groups, but are not the tetra- and higher order copolymers of Class II, but do not necessarily require either maleic-derived or itaconic-derived repeat units. However, terpolymers of maleic, itaconic, and allylsulfonic repeat units, which are per se known in the prior art, will function as the polyanionic copolymer component of the compositions of the invention. The Class IIA copolymers thus are normally copolymers and terpolymers, advantageously including repeat units individually and independently selected from the group consisting of type B, type C, and type G repeat units, without the need for any additional repeat units. Such copolymers can be synthesized in any known fashion, for instance as described in WO 2015/031521.

Class IIA copolymers preferably have at least one of maleic-derived or itaconic-derived repeat units, with the same molecular weight ranges and the other specific parameters (e.g., pH and copolymer solids loading) previously described in connection with the Class II copolymers, and may be converted to partial or complete salts using the same cations and techniques described with reference to the Class I and II Polymer 1 copolymers.

### Polymer II

The Polymer II products disclosed herein are in the form of copolymers, preferably having substantially alternating repeat units, derived from the polymerization of maleic and olefinic repeat unit precursors. Maleic anhydride or maleic acid may be reacted with one or more olefins, as well as additional optional repeat unit precursors, to yield the Polymer II products. Thus, the olefinic repeat units are not restricted to a single type, e.g., a polymer containing substantial proportions of ethylene and propylene olefinic repeat units may be used.

These products preferably contain at least about 85% by weight of maleic and olefinic repeat units, and more preferably consist essentially of maleic and olefinic repeat units. Generally, the usable olefinic repeat units should have between about 2-8 carbon atoms, more preferably from about 2-4 carbon atoms and only 1 olefinically unsaturated carbon-carbon double bond in the repeat unit precursor. In an embodiment, the olefinic repeat units are selected from the group consisting of ethylene and isobutylene repeat units, and mixtures thereof.

The Polymer II copolymers are usually in complete or partial salt form and should be substantially free of amide and anhydride groups (i.e., no more than about 5 mole percent of each, more preferably no more than about 1 mole percent of each). Such copolymers may be conveniently prepared by hydrolysis of available maleic anhydride-olefin copolymers (e.g., maleic anhydride-ethylene), but this is not essential. Useful salt-forming cations include the alkali and alkaline earth metals and/or amines as herein defined, especially where the ratio of carbon atoms to nitrogen atoms does not exceed about 15:1 by mole. Mixtures of such cations may also be used, if desired. Polymer II products may alternately be obtained by conventionally polymerizing selected monomers, followed by formation of partial or complete salts thereof.

The molecular weights of the Polymer II copolymers should be up to about 70,000 Da, and more preferably from about 5,000-15,000 Da. Higher molecular weight products (having a molecular weight of at least about 200,000 Da, more preferably from about 300,000-450,000 Da) may give the overall compositions desirable rheological properties, which are helpful for dust control when the compositions are employed as a dust control additive in the compositions disclosed herein. In such utilities, the higher molecular weight Polymer II products are used in conjunction with the lower molecular weight Polymer II products, where the weight amount of the lower molecular weight product is normally greater than that of the higher molecular weight product.

In some embodiments, the dust control additive component comprises one or more Polymer I products, and one or more Polymer II products. The weight ratio of the Polymer I:Polymer II products in the polyanionic polymer component should range from about 1:19 to about 19:1, more preferably from about 1:3 to about 3:1: the single most preferred compositions have about a 1:1 weight ratio. Both the Polymer I and Polymer II products in the compositions are usually in the form of partial or complete salts.

Generally, the low molecular weight Polymer II product should have a molecular weight of from about 5,000-15,000, whereas the high molecular weight Polymer II product should have a molecular weight of from about 300,000 to 400,000. The ratio of the low molecular weight to high molecular weight Polymer II products is typically in the range of from about 5:1-20:1.

In some embodiments, the dust control additive component comprise a commercially available polyanionic polymer. Exemplary commercially available polymers include, but are not limited to, ISOBAM 600 (which is a maleic acid-isobutylene copolymer).

In some embodiments, the seed treatment composition disclosed herein comprises a dust control additive component in an amount of from about 1% to about 90%, from about 1% to about 80%, from about 5% to about 75%, from about 10% to about 70%, from about 15% to about 65%, from about 20% to about 60%, from about 25% to about 55%, from about 30% to about 50%, from about 35% to about 45%, or from about 40% to about 45% by weight based on the total weight of the seed treatment composition.

### D. Lubricant Additive Component

The lubricant additive present in the seed treatment compositions disclosed herein comprises at least one lipid selected from the group consisting of a wax, a fatty acid alcohol, a fatty acid, or any combination thereof. In some embodiments, the fatty acid alcohol can be selected from a saturated fatty acid alcohol, an unsaturated fatty acid alcohol, and any combination thereof. In some embodiments, the fatty acid can be selected from a saturated fatty acid, an unsaturated fatty acid, and any combination thereof. In some embodiments, the fatty acid or fatty acid alcohol is esterified.

In some embodiments, the lubricant additive component comprises a wax. In some embodiments, the wax is a soft and/or pliable wax. In some embodiments, the wax is an emulsifying wax. In some embodiments, the wax is derived from natural sources. In some embodiments, the wax is selected from the group consisting of beeswax, carnauba wax, sumac wax, paraffin wax, microcrystalline wax, soy wax, sunflower wax, rice bran wax, ceresin wax, ozokerite wax, candelilla wax, fumei wax, emulsifying wax, and a combination thereof.

In some embodiments, the wax is not derived from natural sources. In some embodiments, the wax is a synthetic wax. In some embodiments, the synthetic wax comprises straight-chain, saturated high-carbon alkanes with a molecular weight ranging from about 100 to about 2,500 g/mole, from about 250 to about 2,000 g/mole, from about 300 to about 1,500 g/mole, from about 500 to about 1,000 g/mole, or from about 500 to about 750 g/mole. In some embodiments, the synthetic wax is selected from the group consisting of a Fisher-Tropsch wax, a fatty acid amide wax, a polyolefin wax, polyethylene wax, paraffin wax, microcrystalline wax, and any combination thereof.

In some embodiments, the synthetic wax is a fatty acid amide wax (e.g., a saturated fatty acid amide wax and/or an unsaturated fatty acid amide wax). In some embodiments, saturated fatty amide wax is a compound of Formula (I):

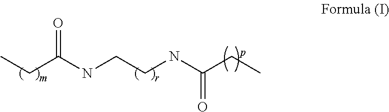

wherein m, r, and p are integers independently selected from 1, 2, 3, 4, 5, 6, 7, 8, 9, 10, 11, 12, 13, 14, 15, 16, 17, 18, 19, and 20.

In some embodiments, m and p are integers independently selected from 8, 9, 10, 11, 12, 13, 14, 15, 16, 17, 18, 19, and 20. In some embodiments, m and p are integers independently selected from 10, 11, 12, 13, 14, 15 and 16.

In some embodiments, r is an integer selected from 1, 2, 3, 4, 5, 6, 7, 8, 9, 10, 11 and 12.

In some embodiments, r is an integer selected from 1, 2, 3, 4 and 5. In some embodiments, r is 2.

In some embodiments, the synthetic wax is an unsaturated fatty acid amide wax comprising
a first fatty acid chain C1;
a second fatty acid chain C2; and
and amine linker.

In some embodiments, the first fatty acid chain C1 and the second fatty acid chain C2 each independently contain at least one olefin. In some embodiments, the first and second fatty acid chain each independently contain from about 4 to about 32 carbon atoms. In some embodiments, the amine linker contains from about 2 to about 10 carbon atoms. In some embodiments, C1 and C2 are independently selected from a straight C16 alkyl chain.

Exemplary unsaturated fatty acid amide waxes include, but are not limited to, the following waxes:

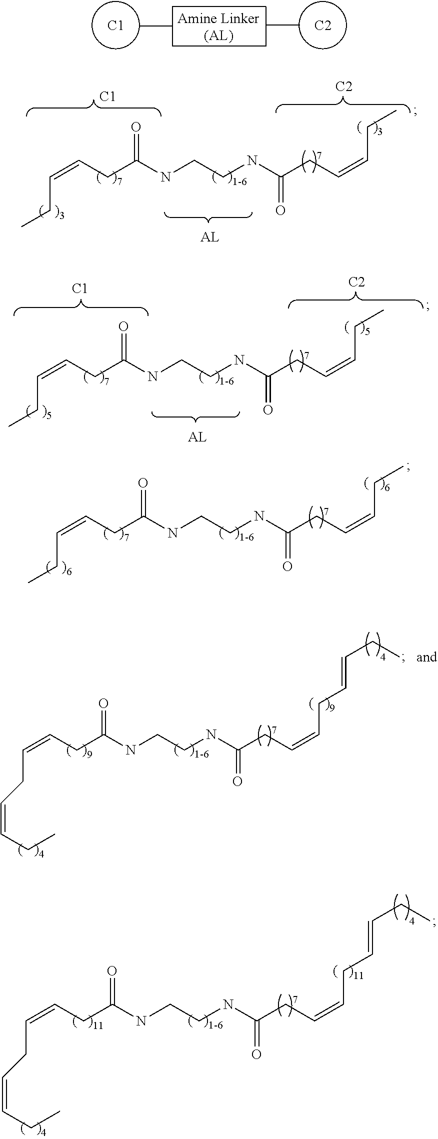

In some embodiments, the synthetic wax is a polyolefin wax. In some embodiments, the polyolefin wax is selected from the group consisting of polyethylene wax, polypropylene wax, polybutylene wax, and a combination thereof. In some embodiments, the polyolefin wax contains an oxidized polyolefin.

In some embodiments, the polyolefin wax contains polyolefins with a molecular weight ranging from about 100 to about 35,000 g/mole, from about 500 to about to about 32,000 g/mole, from about 1,000 to about 30,000 g/mole, from about 5,000 to about 28,000 g/mole, from about 10,000 to about 25,000 g/mole, or from about 12,000 to about 20,000 g/mole.

In some embodiments, the wax is commercially available. Exemplary commercially available synthetic waxes include, but are not limited to, fatty acid amide waxes, synthetic jojoba wax, or a combination thereof.

In some embodiments, the lubricant additive component comprises a fatty acid alcohol or ester thereof. In some embodiments, the fatty acid alcohol comprises about 4 to about 34 carbon atoms, from about 10 to about 34 carbon atoms, from about 14 to about 34 carbon atoms, from about 14 to about 26 carbon atoms, or from about 16 to about 26 carbon atoms. In some embodiments, the fatty acid alcohol or ester thereof is a saturated. In some embodiments, the fatty acid alcohol or ester thereof is unsaturated.

In some embodiments, the fatty acid alcohol is selected from the group consisting of tert-butyl alcohol, tert-amyl alcohol, 3-methyl-3-pentanol, 1-heptanol (enanthic alcohol), 1-octanol (capryl alcohol), pelargonic alcohol (1-nonanol), 1-decanol (decyl alcohol, capric alcohol), undecyl alcohol (1-undecanol, undecanol, hendecanol), lauryl alcohol (dodecanol, 1-dodecanol), tridecyl alcohol (1-tridecanol, tridecanol, isotridecanol), myristyl alcohol (1-tetradecanol), pentadecyl alcohol (1-pentadecanol, pentadecanol), cetyl alcohol (1-hexadecanol), palmitoleyl alcohol (cis-9-hexadecen-1-ol), heptadecyl alcohol (1-n-heptadecanol, heptadecanol), stearyl alcohol (1-octadecanol), oleyl alcohol (1-octadecenol), nonadecyl alcohol (1-nonadecanol), arachidyl alcohol (1-eicosanol), heneicosyl alcohol (1-heneicosanol), behenyl alcohol (1-docosanol), erucyl alcohol (cis-13-docosen-1-ol), lignoceryl alcohol (1-tetracosanol), ceryl alcohol (1-hexacosanol), 1-heptacosanol, montanyl alcohol (cluytyl alcohol, or 1-octacosanol), 1-nonacosanol, myricyl alcohol (melissyl alcohol, or 1-triacontanol), 31-dotriacontanol (lacceryl alcohol), geddyl alcohol (1-tetratriacontanol), and a combination thereof. In some embodiments, the fatty acid alcohol is selected from the group consisting of lauryl alcohol, myristyl alcohol, cetyl alcohol (1-hexadecanol), stearyl alcohol (1-octadecanol), and/or an ester and/or a combination thereof.

In some embodiments, the lubricant additive component comprises a fatty acid or ester thereof. In some embodiments, the fatty acid or ester thereof is saturated. In some embodiments, the fatty acid or ester thereof is unsaturated. In some embodiments, the saturated or unsaturated fatty acid or ester thereof comprises about 3 to about 40 carbon atoms, from about 10 to about 40 carbon atoms, from about 14 to about 38 carbon atoms, from about 14 to about 32 carbon atoms, or from about 14 to about 26 carbon atoms. In some embodiments, the saturated or unsaturated fatty acid or ester thereof comprises about 4 to about 34 carbon atoms, from about 8 to about 34 carbon atoms, from about 12 to about 30 carbon atoms, from about 16 to about 26 carbon atoms, or from about 16 to about 20 carbon atoms.

In some embodiments, the saturated fatty acid is selected from the group consisting of propionic acid (propanoic acid), butyric acid (butanoic acid), valeric acid (pentanoic acid), caproic acid (hexanoic acid), enanthic acid (heptanoic acid), caprylic acid (octanoic acid), pelargonic acid (nonanoic acid), capric acid (decanoic acid), undecylic acid (undecanoic acid), lauric acid (dodecanoic acid), tridecylic acid (tridecanoic acid), myristic acid (tetradecanoic acid), pentadecylic acid (pentadecanoic acid), palmitic acid (hexadecanoic acid), margaric acid (heptadecanoic acid), stearic acid (octadecanoic acid), nonadecylic acid (nonadecanoic acid), arachidic acid (eicosanoic acid), heneicosylic acid (heneicosanoic acid), behenic acid (docosanoic acid), tricosylic acid (tricosanoic acid), lignoceric acid (tetracosanoic acid), pentacosylic acid (pentacosanoic acid), cerotic acid (hexacosanoic acid), carboceric acid (heptacosanoic acid), montanic acid (octacosanoic acid), nonacosylic acid (nonacosanoic acid), melissic acid (triacontanoic acid), hentriacontylic acid (hentriacontanoic acid), lacceroic acid (dotriacontanoic acid), psyllic acid (tritriacontanoic acid), geddic acid (tetratriacontanoic acid), ceroplastic acid (pentatriacontanoic acid), hexatriacontylic acid (hexatriacontanoic acid), heptatriacontylic acid (heptatriacontanoic acid), octatriacontylic acid (octatriacontanoic acid), nonatriacontylic acid (nonatriacontanoic acid), tetracontylic acid (tetracontanoic acid), and any combination and/or an ester thereof. In some embodiments, the saturated fatty acid is selected from the group consisting of caprylic acid, capric acid, lauric acid, myristic acid, palmitic acid, stearic acid, arachidic acid, behenic acid, lignoceric acid, cerotic acid, and any combination thereof. In some embodiments, the saturated fatty acid is stearic acid (octadecanoic acid).

In some embodiments, the fatty acid is selected from the group consisting of lauric acid (dodecanoic acid), tridecylic acid (tridecanoic acid), myristic acid (tetradecanoic acid), pentadecylic acid (pentadecanoic acid), palmitic acid (hexadecanoic acid), margaric acid (heptadecanoic acid), stearic acid (octadecanoic acid), nonadecylic acid (nonadecanoic acid), arachidic acid (eicosanoic acid), heneicosylic acid (heneicosanoic acid), behenic acid (docosanoic acid), and any combination and/or an ester thereof.

In some embodiments, the fatty acid or ester thereof an unsaturated fatty. In some embodiments, the unsaturated fatty acid and/or ester thereof comprises at least one —C═C— double bond. In some embodiments, the unsaturated fatty acid or ester thereof comprises about 4 to about 34 carbon atoms, from about 10 to about 34 carbon atoms, from about 14 to about 34 carbon atoms, from about 14 to about 26 carbon atoms, or from about 16 to about 26 carbon atoms.

In some embodiments, the unsaturated fatty acid is selected from the group consisting of crotonic acid, myristoleic acid, palmitoleic acid, sapienic acid, oleic acid, elaidic acid, vaccenic acid, gadoleic acid, eicosenoic acid, erucic acid, nervonic acid, linoleic acid, eicosadienoic acid, docosadienoic acid, linolenic acid (e.g., α-linolenic acid, γ-linolenic acid), pinolenic acid, eleostearic acid (e.g., α-eleostearic acid, β-eleostearic acid), mead acid, dihomo-γ-linolenic acid, eicosatrienoic acid, stearidonic acid, arachidonic acid, eicosatetraenoic acid, adrenic acid, bosseopentaenoic acid, eicosapentaenoic acid, ozubondo acid, sardine acid, tetracosanolpentaenoic acid, cervonic acid, herring acid, and any combination and/or an ester thereof. In some embodiments, the unsaturated fatty acid is selected from a group consisting of myristoleic acid, palmitoleic acid, sapienic acid, oleic acid, elaidic acid, vaccenic acid, linoleic acid, linoelaidic acid, runenic acid, alpha-Linolenic acid, arachidonic acid, eicosapentaenoic acid, erucic acid, docosaheaenoic acid, and a combination thereof. In some embodiments, the fatty acid is selected from the group consisting of oleic acid, myristic acid, palmitic acid, rumenic acid, vaccenic acid, myrisoleic acid, palmitoeic acid, aluric acid, stearic acid, alpha-linoleic acid, and a combination thereof.

In some embodiments, the lubricant additive component comprises/consists of emulsifying wax, cetyl alcohol, palmitic acid, stearic acid, or a combination thereof. In some embodiments, the lubricant additive component comprises/consists of a fatty acid, a synthetic wax, or a combination thereof.

The amount of lubricant additive component present in the seed treatment composition can vary depending on the type of lubricant additive and a skilled artisan would be aware of that and adjust the amount accordingly. In some embodiments, the amount lubricant additive component present in the seed treatment composition is from about 0.1% to about 50%, from about 1% to about 40% from about 1% to about 25%, from about 1% to about 10%, from about 1% to about 7.5%, from about 1% to about 6%, from about 1% to about 5%, from about 1% to about 2.5%, from about 2.5% to about 7.5%, from about 2.5% to about 5%, or from about 5% to about 7.5% weight based on the total weight of the seed treatment composition. In some embodiments, the lubricant additive component present in the seed treatment composition is from about 0.1% to about 25%, from about 0.1% to about 20%, from about 0.1% to about 10%, from about 0.5% to about 10%, from about 1% to about 10% by weight based on the total weight of the seed treatment composition. In some embodiments, the amount of lubricant additive component present in the seed treatment composition is less than about 50%, about 45%, about 40%, about 35%, about 30%, about 25%, about 20%, about 15%, about 12%, about 10%, about 9%, about 8%, about 7%, about 6%, about 5%, about 4%, about 3%, about 2%, about 1%, about 0.5% or less than about 0.1% by weight based on the total weight of the seed treatment composition.

In some embodiments, the lubricant additive component reduces the amount of caking of a seed treatment composition. In some embodiments, the lubricant additive component disclosed herein reduces caking of a seed treatment composition by at least about 80%, at least about 90%, at least about 91%, at least about 92%, at least about 93%, at least about 94%, at least about 95%, at least about 96%, at least about 97%, or at least about 98% compared to seed treatment compositions that do not include a lubricant additive component as disclosed herein. In some embodiments, the lubricant additive reduces the amount of caking of a seed treatment composition in an amount ranging from about 90% to about 99%, from about 90% to about 98%, from about 92% to about 98%, from about 92% to about 96%, or from about 94% to about 96% compared to seed treatment compositions that do not include a lubricant additive as disclosed herein.

In some embodiments, the seed treatment composition as disclosed herein comprises a flour component (e.g., grain flour) present in an amount of from about 45% to about 65% by weight, a powdered protein component present in an amount of from about 30% to about 50% by weight, and a lubricant additive component present in an amount of from about 1% to about 10% by weight based on the total weight of the seed treatment composition. In such compositions, the flour component is wheat flour, the powdered protein component is soy protein powder, and the lubricant additive component is selected from stearic acid, emulsifying wax, cetyl alcohol, and a combination thereof. Exemplary, seed treatment compositions are shown in Table 1 below.

TABLE 1
Compositions of the experimental blends

| Ingredient | Blend 1 | Blend 2 | Blend 3 | Blend 4 | Blend 5 | Blend 6 | Blend 7 |
|---|---|---|---|---|---|---|---|
| Wheat flour | 47.5 g | 47.5 g | 45 g | 45 g | 61.3 g | 62.3 g | 47.5 g |
| Soy protein powder | 47.5 g | 47.5 g | 45 g | 45 g | 30.7 g | 31.2 g | 47.5 g |
| Stearic acid | 2.5 g | 2.5 g | 5 g | 5 g | 7.5 g | 5.0 g | |
| Emulsifying wax | 2.5 g | 2.5 g | 5 g | 5 g | | | 2.5 g |
| Cetyl alcohol | | | | | | | 2.5 g |
| Soy wax | | | | | | 1.0 g | |
| Soy oil | | | | | 0.5 g | 0.5 g | |
| Total | 100 g | 100 g | 100 g | 100 g | 100 g | 100 g | 100 g |
| Mixing method | Machine | Hand | Machine | Hand | Machine | Machine | Machine |
| | grinding | mixing | grinding | mixing | grinding | grinding | grinding |

In some embodiments, the seed treatment composition as disclosed herein comprises a flour component (e.g., grain flour) present in an amount of from about 40 to about 50% by weight, a powdered protein component present in an amount of from about 40% to about 50% by weight a lubricant additive component present in an amount of from about 1 to about 10 by weight, and a dust control additive component present in an amount of from about 1% to about 5% based on the total weight of the seed treatment composition. In such compositions, the flour component is wheat flour, the powdered protein component is soy protein powder, the lubricant additive component is bees wax, and the dust control additive component is selected from a polyanionic T5 polymer, an ISOBAM 600 polymer, a sodium alginate polymer, and a combination thereof. Exemplary, seed treatment compositions are shown in Table 1.1 below.

TABLE 1.1
Additional Compositions of the experimental blends

| Ingredient | Blend 8 | Blend 9 | Blend 10 | Blend 11 | Blend 12 |
|---|---|---|---|---|---|
| Wheat flour | 46.5 | 45 | 45 | 45 | 45 |
| Soy protein powder | 46.5 | 45 | 45 | 45 | 45 |
| Stearic acid | 5 | 5 | 5 | 3 | 3 |
| Emulsifying wax | | | | | |
| Cetyl alcohol | | | | | |
| Soy wax | | | | | |
| Bees wax | 2 | 2 | 2 | 2 | 2 |
| Soy oil | | | | | |
| T5 polymer | | 3 | | | |
| ISOBAM 600 | | | 3 | 2.2 | |
| Ammonium hydroxide | | | | 0.8 | |
| Sodium alginate | | | | | 3 |
| Total | 100 g | 100 g | 100 g | 100 g | 100 g |
| Mixing method | Machine | Machine | Machine | Machine | Machine |
| | grinding | mixing | grinding | mixing | grinding |

In some embodiments, the seed treatment compositions disclosed herein can be used as a plant seed flow lubricant to improve the flowability of plant seeds. In some embodiments, the seed treatment composition disclosed herein improves flowability of plants seeds by at least about 10% or more, about 12% or more, about 15% or more, about 20% or more, or about 25% or more compared to the flowability of untreated plant seeds. In some embodiments, the seed treatment composition disclosed herein improves flowability of plant seeds from about 10% to about 25%, from about 10% to about 16%, or from about 10% to about 12% compared to the flowability of untreated seeds.

In some embodiments, the seed treatment composition disclosed herein improves flowability of plant seeds by at least about 3% or more, at least about 5% or more, at least about 6% or more, at least about 7% or more, at least 8% or more, at least 9% or more, or at least 10% or more compared to talc-based lubricant compositions. In some embodiments, the seed treatment composition disclosed herein improves flowability of plant seeds from about 2% to about 10%, from about 3% to about 8%, from about 3.5% to about 7.5%, from about 4% to about 7.5%, from about 5.5 to about 7.5%, from about 5.5 to about 7.0%, from about 5.5% to about 6.5%, from about 6% to about 7.5%, from about 6.5% to about 7.5%, or from about 6.5% to about 7% compared to talc-based lubricant compositions, e.g., commercially available talc-based lubricant compositions containing a 80:20 talc and graphite mixture.

In some embodiments, the seed treatment composition disclosed herein improves flowability of plant seeds by at least about 3% or more, at least about 5% or more, at least about 8% or more, at least about 10% or more, at least 11% or more, at least 12% or more, at least 13% or more, at least 14% or more, or at least 15% or more compared to untreated seed compositions (i.e., seeds only). In some embodiments, the seed treatment composition disclosed herein improves flowability of plant seeds from about 2% to about 20%, from about 5% to about 15%, from about 10% to about 15%, from about 11% to about 15%, from about 12 to about 15%, from about 13 to about 15%, from about 13.5% to about 15%, from about 14% to about 15%, from about 14.5% to about 15%, compared to untreated compositions, e.g., seeds only.

In some embodiments, the seed treatment composition disclosed herein reduces formation of plant seed dust of plant seeds by at least about 30%, about 40%, about 50%, about 60%, about 65%, about 70%, about 75%, about 80%, about 85%, about 90%, or at least about 92% or more compared to talc-based lubricant composition. In some embodiments, the seed treatment composition disclosed herein reduces formation of plant seed dust of plant seeds from about 30% to about 95%, from about 40% to about 95%, from about 50% to about 95%, from about 60% to about 95%, from about 65% to about 92%, from about 65% to about 90%, from about 65% to about 86%, from about 65% to about 80% from about 65% to about 78%, from about 65% to about 76%, from about 65% to about 70%, from about 70% to about 92%, from about 75% to about 92%, from about 78% to about 92%, from about 86% to about 92%, from about 89% to about 92%, or from about 70% to about 90% compared to talc-based lubricant composition, e.g., commercially available talc-based lubricant compositions containing a 80:20 talc and graphite mixture.

A skilled artisan would be aware that the seed flow and/or seed dust can vary depending on the type of seed is being used.

### IV. Formulations

The disclosed seed treatment compositions can be used in unmodified original form (e.g., neat) or can be formulated into formulations containing the disclosed seed treatment compositions. In some embodiments, the formulation comprises the seed treatment composition disclosed herein (referred to as seed treatment formulation) and at least one material selected from inert materials, inactive agents, and/or solid lubrication materials.

In some embodiments, the seed treatment composition further comprises at least one or more inert materials. Blending the disclosed seed treatment composition with such inert materials is done to improve the handling and/or packaging of the seed treatment composition. Exemplary inert materials include, but are not limited to, silica, starches, (natural and derived), clays, mineral, and a combination thereof. In some embodiments, the seed treatment composition is formulated to include at least one inert material selected from silicon dioxide, starches, oils (synthetic or natural derived), starch glycolates, bentonite, diatomaceous earth, kaolin, cellulose, microcrystalline cellulose, stearates (e.g., magnesium or calcium stearate), colorants, dyes, or a combination thereof. In some embodiments, the inert material is soy oil.

In some embodiments, the seed treatment formulation further comprises at least one inactive agent selected from preservatives, anticaking agents, antioxidants, surfactants, stabilizers, pH adjustor, solid carriers and a combination thereof. Blending the disclosed seed treatment composition with such inactive agents is done to improve the longevity and/or shelf life of the seed treatment composition. In some embodiments, the at least one inactive agent is in solid form. A skilled artisan would be aware of suitable inactive agents to employ in the seed treatment composition disclosed herein. For example in some embodiments the at least one inactive agent is a solid carrier. Exemplary solid carriers include, but are not limited to, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

In some embodiments, the seed treatment composition further comprises at least one additional solid lubrication material. Blending the disclosed seed treatment composition with such solid lubrication material is done to improve/enhance the lubrication properties of the seed treatment composition disclosed herein. A skilled artisan would be aware of suitable solid lubrication materials and how to employ them in the seed treatment composition disclosed herein. Exemplary solid material lubricant materials include, but are not limited to, molybdenum disulfide (MoS₂), polytetrafluoroethylene (PTFE; teflon), graphite, boron nitride, calcium fluoride, cerium fluoride, tungsten disulfide, and a combination thereof.

The amount of each of such materials (e.g., inert materials, inactive agents, and/or solid lubricant materials) present in the seed treatment formulation can vary. In some embodiments, the amount of such materials (individually or combined) present in the seed treatment formulation may be less than about 50%, less than about 40%, less than about 30%, less than about 20%, less than about 10%, less than about 5%, less than about 2.5%, less than about 1%, less than about 0.3%, less than about 0.1%, or less than about 0.03% by weight of the seed treatment formulation.

In some embodiments, the formulations disclosed herein do not include talc. In another embodiment, the formulations disclosed herein do not include graphite or graphite blends. In yet another embodiment, the formulations disclosed herein is talc and/or graphite free, i.e., the seed formulations do not include blends of graphite and/or talc. In another embodiment, the formulations disclosed herein contain trace amounts of talc or graphite (i.e., an amount less than 0.1% by weight based on the total weight of the formulation). In another embodiment, the formulations disclosed herein contain less than about 0.5%, less than about 1%, less than about 5%, less than about 10%, less than about 20%, less than about 20%, less than about 30%, less than about 40%, or less than about 50% by weight of talc, graphite, or a combination of talc or graphite, based on the total weight of the seed treatment composition.

### V. Seed Compositions

Another aspect of the present disclosure provides a seed composition comprising a plurality of plant seeds and any of the seed treatment compositions detailed above in section (III) and/or (IV). In some embodiments, the plant seeds that can be used in combination with the disclosed seed treatment composition are selected from the group consisting of grain plant seeds, legume plant seeds, cereal plant seeds, grass plant seeds, vegetable plant seeds, oil seeds, cotton seeds, and any combination thereof.

In some embodiments, the plant seeds may be cereal seeds. Exemplary cereal seeds include, but are not limited to, seeds of rice, barley, wheat, spelt, einkorn, emmer, durum, barley, sorghum, millet, oats, rye, corn, triticale, quinoa, and buckwheat.

In some embodiments, the plant seeds may be any vegetable plant seed. Exemplary vegetable seeds include, but are not limited to, artichoke, arugula, asparagus, beans (all), beet, broccoli, broccoli raab/rapini, brussel sprouts, cabbage, carrot, cauliflower, celery, chicory, collard greens, corn, cucumber, eggplant, endive, fennel, garlic, gourd, kale, kohlrabi, leek, leafy greens, lettuce, melon, mustard, okra, onions, parsnip, peas, peppers (hot), peppers (sweet), potatoes, pumpkin, radish, radicchio, rutabaga, rhubarb, shallots, spinach, sprouts, squash, Swiss chard, tomatillo, tomato, turnip, watermelon, wheat or a combination thereof.

In some embodiments, the plant seeds may be legume plant seeds. Examples of legume plant seeds include but are not limited to a soybeans, lentils, peanuts, chickpeas, cowpeas, lima beans, adzuki beans, green beans, haricot beans, mung beans, winged bean, yard-long bean, runner beans, kidney beans, alfalfa, clover, or a combination thereof. In some embodiments, the legume seeds are selected from the group consisting of chickpeas, peanuts, black beans, green peas, lima beans, kidney beans, black-eyed peas, navy beans, great northern beans, pinto beans, soybeans, lentils, adzuki beans, lupins, alfalfa, and a combination thereof.

In some embodiments, the plants seeds may be grass seeds for lawns, pastures, forage uses, cover crops, and turf uses. Suitable grass seeds include ryegrass (e.g., annual ryegrass, perennial ryegrass, winter ryegrass, Italian ryegrass, hybrid ryegrass), bluegrass (e.g., Kentucky), and fescue (e.g., red fescue, fescue, meadow fescue, tall fescue, Lucerne fescue).

In further embodiments, the plant seeds may be cotton seeds (Gossypium hirsutum), oil seeds of the Crucifer family, such as canola (B. campestris) and oilseed rape (B. napus), seeds of other Crucifer plant species including those of plants of the B. oleraceae such as seeds of cabbages, broccolis, cauliflowers, kales, brussel sprouts, and kohlrabies; seeds of alliums including onion, leek and garlic. Other suitable field crop plant seeds include capsicums, tomatoes, cucurbits such as cucumbers, cantaloupes, summer squashes, pumpkins, butternut squashes, tropical pumpkins, calabazas, winter squashes, watermelons, lettuces, zucchinis, eggplants, beets, carrots, parsnips, rutabaga, turnips, sugar beets, celeriacs, Jerusalem artichokes, artichokes, bok choi, celery, Chinese cabbage, horse radish, musk melons, parsley, radish, spinach, linseed, sunflower, safflower, sesame, carob, coriander, mustard, grape, flax, dika, hemp, okra, poppy, castor, jojoba, and the like.

In some embodiments, the plant seeds may be untreated seeds, i.e., seeds that have not been treated using any chemical, biological, or physical method. In other embodiments, the plant seeds may be treated plant seeds, i.e., seeds that have been treated or coated with one or more active ingredients. Suitable active ingredients include fertilizers, plant growth regulators, fungicides, insecticides, or combinations thereof. The seed treatment or coating may further comprise synthetic polymers in combination with the active ingredient(s). Examples of polymers used to coat plant seeds include petroleum-based polymers such as polyvinyl alcohol (also known as PVOH), polyacrylic acids, polymethacrylic acids, polyacrylates, polymethacrylates, polyvinyls, polyvinyl acetates, polyurethanes, polyurethane acrylics, polyesters, polyethylene oxides, polypropylene oxides, cellulose derived polymers such as methyl cellulose, ethyl cellulose, hydroxypropylmethyl cellulose, hydroxypropyl cellulose, or hydroxypropylethyl cellulose, combinations thereof, or co-polymers of any of the foregoing.

In some embodiments, the seed of the seed composition is selected from the group consisting of alfalfa, barley, oats, rye, corn, cotton, milo, millets, sorghum, peanuts, rice, soybeans, sugar beets, sunflowers, wheat, and a combination thereof.

The amount of seed treatment composition present in the seed composition can and will vary depending upon the components in the seed treatment composition and the type of seeds. In general, the amount of seed treatment composition present in the seed composition may range from about 0.0001% to about 10%, from about 0.01% to about 5%, from about 0.01% to about 2%, or from about 0.01% to about 1% by weight based on the total weight of the seed composition. In some embodiments, the amount of seed treatment composition present in the seed composition may range from about 0.005% to about 0.01% by weight of the seed composition (e.g., about 1-10 ounces per 50 pounds of seed).

In some embodiments, the disclosed seed treatment composition contains the seed composition and plant seeds in a weight ratio ranges from about 0.0001:1 to about 0.01:1

### V. Agricultural Compositions

In some embodiments, the seed treatment composition may further comprise at least one active ingredient. Suitable active ingredients include micronutrients, macronutrients, biostimulants, biologicals, biocontrol, rhizobium inoculums, fertilizers, pesticide (insecticides, fungicides, herbicides, etc.), or combinations thereof.

A. Micronutrients and/or Macronutrients

In some embodiments, the seed treatment composition may further comprise at least one micronutrients and/or macronutrient. In some embodiments, the at least one micronutrient is selected from the group consisting of boron (B), cobalt (Co), chlorine (Cl), copper (Cu), iron (Fe), manganese (Mn), molybdenum (Mo), nickel (Ni) and zinc (Zn). In some embodiments, the at least one macronutrient is selected from the group consisting of nitrogen (N), phosphorus (P), potassium (K), calcium (Ca), magnesium (Mg), sulfur (S), and a combination thereof.

The amount of each micronutrient and/or macronutrient present in the seed treatment composition can vary. In some embodiments, the amount of each micronutrient present in the seed composition is from about 0.0001% to about 20%, from about 0.0001 to about 15%, from about 0.0001 to about 10%, from about 0.01% to about 10%, from about 0.1% to about 10%, from about 0.5% to about 5%, or from about 1% to about 2.5% by weight based on the total weight of the seed treatment composition.

### B. Biostimulants

In some embodiments, the seed treatment composition may further comprise a biostimulant. As used herein, the term “biostimulant” refers to a compound stimulating plant nutrition processes independently of the compound's nutrient content, with the main aim of improving one or more of the following characteristics of the plant: nutrient use efficiency, tolerance to abiotic stress, crop quality, and treat or availability of confined nutrients in the soil of rhizosphere.

Exemplary classes of other biostimulants include, but are not limited to, protein hydrolysates (e.g., amino acids and peptides mixtures obtained by chemical and enzymatic protein hydrolysis from both plant sources and animal wastes), humic acid and fulvic acid containing compositions (e.g., any organic acids that occur naturally in soil, resulting from the decomposition of plant, animal and microbial residues), pyroglutamic acid, seaweed extracts and botanicals, chitosan and other biopolymers, inorganic compounds (e.g., minerals such as silica, selenium, cobalt and others which promote plant growth, the quality of plant products and tolerance to abiotic stress), various phenolic compounds, keto compounds, phite compounds and/or beneficial bacteria and fungi (e.g., Bacillus and Rhizobium fungi). See Jardin et al., “Plant biostimulants: Definition, concept, main categories and regulation,” Scientia Horticulturase, 2015, 196:3-14, which is hereby incorporated by reference in its entirety.

The amount of biostimulant present in the seed treatment composition can vary. In some embodiments, the amount of biostimulant present in the seed composition is from about 0.0001% to about 20%, from about 0.0001 to about 15%, from about 0.0001 to about 10%, from about 0.01% to about 10%, from about 0.1% to about 10%, from about 0.5% to about 5%, or from about 1% to about 2.5% by weight based on the total weight of the seed treatment composition.

### C. Biological Agents

In some embodiments, the disclosed seed treatment composition may further comprise at least one biological agent. As used herein, “biological agent” refers to a range of microorganisms that are able to modulate the nutrient content in the soil. Exemplary biological agents include, but are not limited to nitrogen fixation microbes, phosphate-solubilizing microorganisms, arbuscular mycorrhizal (AM) fungi, and others. In some embodiments, the biological agent can be any combination of nitrogen fixation microbes, phosphate-solubilizing microorganisms, mycorrhizae, and others.

In some embodiments, the biological agent is a nitrogen fixation microbe. As used herein, the term “nitrogen fixation microbe” refers to organisms that modulate nitrogen fixation, which is a chemical process by which molecular nitrogen, with a strong triple covalent bond, in the air is converted into ammonia or related nitrogenous compounds, typically in soil. Exemplary nitrogen fixation microbes include, but are not limited to, species of Azotobacter, Azoarcus, Bacillus, Beijerinckia, Clostridium, Derxia, Ensifer, Frankia, Klebsiella, Azospirillum, Gluconacetobacter, Herbasprillum, Bradyrhizobium, Poaceae, Anabaena, Nostoc, Rhizobium, Methanobacterium, or any combination thereof.

In some embodiments, the biological agent is a phosphate-solubilizing microorganism. As used herein, the term “phosphate-solubilizing microorganism” refers to microorganisms capable of solubilizing inorganic phosphorus from insoluble compounds. Exemplary phosphate-solubilizing microorganisms include, but are not limited to, species of Aspergillus, Penicillium, Bacillus, Pseudomonas, Micrococcus, Fusarium, Paenibacillus, Pantoea, Rhizobium, Mesorhizobium, Arthrobotrys, Trichoderma, or any combination thereof.

In some embodiments, the biological agent is a mycorrhizae. As used herein, “mycorrhizae” refers to a beneficial fungus to the plant roots and spread out into the soil and gather nutrients and moisture for the plant, which in turn provides the fungus with sugars passed down to its roots. The term mycorrhiza can refer to both the role of the fungi in the plants' root system breaking down nutrients to become more readily available for the plant as well as the fungus itself. Mycorrhizal fungi is typically more common in soil and soilless media where it tends to create fungal colonies better than in hydroponic environments but there are some mycorrhizae specially made for hydroponics. Mycorrhizae literally translates to “fungus-root.” Mycorrhiza defines a (generally) mutually beneficial relationship between the root of a plant and a fungus that colonizes the plant root. In many plants, mycorrhiza grow inside the plant's roots (endomycorrhiza), or on the surfaces of the roots (ectomycorrhiza). The plant and the fungus have a mutually beneficial relationship, where the fungus facilitates water and nutrient uptake in the plant, and the plant provides food and nutrients created by photosynthesis to the fungus. This exchange is a significant factor in nutrient cycles and the ecology, evolution, and physiology of plants.

In some embodiments, the mycorrhizae disclosed herein can be an ectomycorrhiza or an endomycorrhiza. In some embodiments, the mycorrhizae disclosed herein is an endomycorrhiza selected from the group consisting of arbuscular, ericoid, arbutoid, monotropoid, and orchid mycorrhizae. In some embodiments, the mycorrhizae disclosed herein is an arbuscular mycorrhizal (AM) fungi. In some embodiments, the AM fungi is selected from the species of Glomus, Gigaspora, Scutellospora, Acaulospora, Entrophospora, Rhizophagus, Claroldeoglomus, and a combination thereof.

### D. Biocontrol Agents

In some embodiments, the disclosed seed treatment composition may further comprise at least one biocontrol agent. The term “biocontrol agent” as used herein refers to a microbial strain able to suppress populations of different pest insects, fungi, or disease. In some embodiments, the biocontrol agent is selected from the group consisting of fungi, bacteria, nematodes, or a combination thereof.

In some embodiments, the biocontrol agent is a fungus. Exemplary fungi include, but are not limited to, the following species Alternaria, Aspergillus, Candida, Ampelomyces, Anthracocystis, Beauveria, Cordyceps, Metarhizium, Lagenidium, Penicillium, Pichia, Talaromyces, Paraphaeosphaeria, Clonostachys, Fusarium, Phlebiopsis, Trichoderma, Purpureocillium, or Verticillium.

In some embodiments, the biocontrol agents are bacteria. Exemplary bacteria include, but are not limited to, the following species Bacillus (e.g, Bacillus thuringiensis, Bacillus popilliae, Bacillus sphaericus, Bacillus subtilis, Bacillus, pumilus, Bacillus mycoides), Lysinibacillus sphaericus, Paenibacillus, Brevibacillus (e.g., Brevibacillus laterosporus), Clostridium (e.g., Clostridium bifermentans), Photorhabdus, Xenorhabdus, Serratia. Yersinia (e.g., Yersinia entomophaga), Burkholderia, Chromobacterium, Streptomyces, or Saccharopolyspora (e.g., Saccharopolyspora spinose).

In some embodiments, the biocontrol agent is a nematode. Exemplary nematodes include, and are not limited to, Steinernema carpocapsae, Steinernema feltiae, Steinernema riobrave, Heterorhabditis bacteriophora, Heterorhabditis marelatus or Heterorhabditis megidis.

### E. Pesticides

In some embodiments, the disclosed seed treatment composition may further comprise at least one pesticide. As used herein, “pesticide” refers to any agent with pesticidal activity (e.g., herbicides, insecticides, fungicides, and/or miticides) and is preferably selected from the group consisting of insecticides, herbicides, and mixtures thereof, but normally excluding materials which assertedly have plant-fertilizing effect, for example, sodium borate and zinc compounds such as zinc oxide, zinc sulfate, and zinc chloride. For an unlimited list of pesticides, see “Farm Chemicals Handbook 2000, 2004” (Meister Publishing Co, Willoughby, OH), which is hereby incorporated by reference in its entirety.

Exemplary herbicides include, but are not limited to acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfiuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like.

Exemplary insecticides include, but are not limited to 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypennethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlonnephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A &B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacmb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumiethrin, fluorbenside, fluvalinate, fonofos, fonmetanate, formothion, formparanate, fosmethilan, fospirate, fosthiazate, fosthietan, fosthietan, fiurathiocarb, furethrin, furfutral, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin H, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vaniliprole, XMC, xylylcarb, zeta cypermethrin and zolaprofos.

Exemplary fungicides include, but are not be limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylamine, calcium polysulfide, captafol, captan, carbamate fiugicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylene oxide, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, Fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, firalaxyl, furametpyr, furamide fungicides, furanilide fungicides, furcarbanil, furconazole, firconazole-cis, furfural, furmecyclox, furophanate, glyodin, griseofidvin, guazatine, halacrinate, hexachlorobenzene, hexachlorobutadiene, hexachlorophene, hexaconazole, hexylthiofos, hydrargaphen, hyrnexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, lime sulfur (lime sulphur), mancopper, mancozeb, maneb, mebenil, mecarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylnercury)-p-toluenesulfonanilide, nabam, natamycin, nystatin, β-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefirazoate, penconazole, pencycuron, pentachlorophenol, penthiopyrad, phenyhnercuriurea, phenylnercury acetate, phenylmercury chloride, phenylmercury derivative of pyrocatechol, phenyhnercury nitrate, phenylmercury salicylate, phenylsulfamide fungicides, phosdiphen, Phosphite, phthalide, phthalimide fungicides, picoxystrobin, piperalin, polycarbamate, polymeric dithiocarbamate fimgicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fimgicides, pyrazophos, pyridine fungicides, pyridinitril, pyrifenox, pyrimethanil, pyrimidine fungicides, pyroquilon, pyroxychlor, pyroxyfur, pyrrole fimgicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, uniconazole-P, urea fungicides, validamycin, valinamide fungicides, vinclozolin, voriconazole, zarilamid, zinc naphthenate, zineb, ziram, and/or zoxamide.

Exemplary classes of miticides include, but are not be limited to botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricies, organitin acaricides, phenylsulfonamide acaricides, pyrazolecarboxamide acaricdes, pyrethroid ether acaricide, quaternary ammonium acaricides, oyrethroid ester acaricides, pyrrole acaricides, qumoxaline acaricides, methoxyacrylate strobilurin acaricides, teronic acid acaricides, thiasolidine acaricides, thiocarbamate acaricides, thiourea acaricides, and unclassified acaricides. Examples of miticides for these classes include, but are not limited to, to botanical acaricides—carvacrol, sanguinarine; bridged diphenyl acaricides—azobenzene, benzoximate, benzyl, benzoate, bromopropylate, chlorbenside, chlorfenethol, chlorfenson, chlorfensulphide, chlorobenzilate, chloropropylate, cyflumetofen. DDT, dicofol, diphenyl, sulfone, dofenapyn, fenson, fentrifanil, fluorbenside, genit, hexachlorophene, phenproxide, proclonol, tetradifon, tetrasul; carbamate acaricides—benomyl, carbanolate, carbaryl, carbofuan, methiocarb, metolcarb, promacyl, propoxur; oxime carbamate acaricides—aldicarb, butocarboxim, oxamyl, thiocarboxime, thiofanox; carbazate acaricides—bifenazate; dinitrophenol acaricides—binapacryl, dinex, dinobuton, dinocap, dinocap-4, dinocap-6, dinocton, dinopenton, dinosulfon, dinoterbon, DNOC; formamidine acaricides—amitraz, chlordimeform, chloromebuform, fornetanate, fornparanate, medimeform, semiamitraz; isoxazoline acaricides—afoxolaner, fluralaner, lotilaner, sarolaner; macrocyclic lactone acaricides—tetranactin; avermectin acaricides—abamectin, doramectin, eprinomectin, ivermectin, selamectin; milbemycin acaricides—milbemectin, milbemycin, oxime, moxidectin; mite growth regulators—clofentezine, cyromazine, diflovidazin, dofenapyn, fluazuron, flubenzimine, flucycloxuron, flufenoxuron, hexythiazox; organochlorine acaricides—bromociclen, camphechlor, DDT, dienochlor, endosulfan, lindane; organophosphate acaricides—chlorfenvinphos, crotoxyphos, dichlorvos, heptenophos, mevinphos, monocrotophos, naled, TEPP, tetrachlorvinphos; organothiophosphate acaricides—amidithion, amiton, azinphos-ethyl, azinphos-methyl, azothoate, benoxafos, bromophos, bromophos-ethyl, carbophenothion, chlotpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, fonmothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides—trichlorfon; phosphoramidothioate acaricides—isocarbophos, methamidophos, propetamphos; phosphorodiamide acaricides—dinmefox, mipafox, schradan; organotin acaricides—azocyclotin, cyhexatin, fenbutatin, oxide, phostin; phenylsulfamide acaricides—dichlofluanid; phthalimide acaricides—dialifos, phosmet; pyrazole acaricides—cyenopyrafen, fenpyroximate; phenylpyrazole acaricides—acetoprole, fipronil, vaniliprole; pyrazolecarboxamide acaricides—pyflubumide, tebufenpyrad; pyrethroid ester acaricides—acrinathrin, bifenthrin, brofluthrinate, cyhalothrin, cypermethrin, alpha-cypennethrin, fenpropathrin, fenvalerate, flucythrinate, flumethrin, fluvalinate, tau-fluvalinate, permethrin; pyrethroid ether acaricides—halfenprox; pyrimidinamine acaicides—pyrimidifen; pyrrole acaricides—chlorfenapyr; quaternary ammonium acaricides—sanguinarine; quinoxaline acaricides—chinomethionat, thioquinox; methoxyacrylate strobilurin acaricides—bifujunzhi, fluacrypyrim, flufenoxystrobin, pyriminostrobin; sulfite ester acaricides—aramite, propargite; tetronic acid acaricides—spirodiclofen; tetrazine acaricides, clofentezine, diflovidazin; thiazolidine acaricides—flubenzimine, hexythiazox; thiocarbamate acaricides—fenothiocarb; thiourea acaicides—chloromethiuron, diafenthiuron; unclassified acaricides—acequinocyl, acynonapyr, amidoflumet, arsenous, oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azimphos-methyl, Bacillus thuringiensis, bendiocarb, beta-cyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chloipyrifos, clofentezine, chlorfenapyr, clothianidin, coumaphos, crotoxyphos, crotoxyphos+dichlorvos, cryolite, cyfluthrin, cyromazine, cypennethrin, deet, deltamethrin, demeton, diazinon, dichlofenthion, dichloropropene, dichlorvos, dicofol, dicrotophos, dieldrin, dienochlor, diflubenzuron, dikar (fungicide+miticide), dimethoate, dinocap, dinotefuran, dioxathion, disulfoton, emamectin benzoate, endosulfan, endrin, esfenvalerate, ethion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, methoprene, methoxychlor, methoxyfenozide, methyl bromide, methyl parathion, mevinphos, mexacarbate, Milky Disease Spores, naled, naphthalene, nicotine sulfate, novahtron, oxamyl, oxydemeton-methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids—synthetic: see allethrin, permethrin, fenvalerate, resmethrin, pyrethum, pyridaben, pyriproxyfen, resmethrin, rotenone, s-methoprene, soap, pesticidal, sodium fluoride, spinosad, spiromesifen, sulfotep, sulprofos, temephos, terbufos, tetrachlorvinphos, tetrachlorvinphos+dichlorvos, tetradifon, thiamethoxam, thiodicarb, toxaphene, tralomethrin, trimethacarb, and tebufenozide.

The amount of pesticide in the pesticide/seed treatment dual composition can vary. In some embodiments, the amount of pesticides is present at a level of from about 0.05-10% by weight (more preferably from about 0.1%-4% by weight, and most preferably from about 0.2-2% by weight) based upon the total weight of the pesticide/seed treatment containing composition taken as 100% by weight.

### F. Fertilizers

In some embodiments, the agricultural product is a fertilizer. The fertilizer can be a solid fertilizer, such as, but not limited to a granular and/or prill-like fertilizer, and the seed treatment composition and/or formulation can be intermixed therewith. The fertilizer can also be in a semi-solid form (e.g., manure) where the seed treatment composition and/or formulation can also be intermixed therewith.

In some embodiments, the fertilizer is or contains urea and/or ammonia, including anhydrous ammonia fertilizer. In some embodiments, the fertilizer can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, and/or fertilizers containing copper. In some embodiments, the additional fertilizer comprises plant-available nitrogen, phosphorous, potassium, sulfur, calcium, magnesium or micronutrients. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, Co, Mo, V and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material). In some embodiments, the additional fertilizer is an NPK fertilizer.

When the described seed treatment composition, or formulations thereof, is applied with the application of one or more fertilizers, the seed treatment composition can be applied prior to, subsequent to, or simultaneously with the application of fertilizer(s).

### VI. Methods

In some embodiments, the seed treatment compositions are used directly. In other embodiments, the seed treatment compositions are formulated in ways to make their use convenient in the context of productive agriculture. The seed treatment compositions used in these methods include the flour component, powdered protein component, and the lubricant additive component as described above. The seed treatment compositions can be used in methods such as:
A. Methods of improving seed flowability
B. Methods of reducing plant seed dust
C. Methods of improving plant growth and/or increasing crop yield
D. Methods of making a seed treatment compositions

A. Methods of improving plant seed flowability comprises contacting seeds with a seed treatment composition disclosed herein. In such methods, the flowability of plants seeds is improved by at least about 3% or more, at least about 5% or more, at least about 6% or more, at least about 7% or more, at least 8% or more, at least 9% or more, or at least 10% or more compared to the flowability of plant seeds treated with talc-based lubricant compositions. In some embodiments, the methods disclosed herein improve flowability of plant seeds from about 2% to about 10%, from about 3% to about 8%, from about 3.5% to about 7.5%, from about 4% to about 7.5%, from about 5.5 to about 7.5%, from about 5.5 to about 7.0%, from about 5.5% to about 6.5%, from about 6% to about 7.5%, from about 6.5% to about 7.5%, or from about 6.5% to about 7% compared to the flowability of plant seeds treated with talc-based lubricant compositions, e.g., commercially available talc-based lubricant compositions containing a 80:20 talc and graphite mixture, when used in these methods.

In some embodiments, the methods disclosed herein improve flowability of plant seeds by at least about 3% or more, at least about 5% or more, at least about 8% or more, at least about 10% or more, at least 11% or more, at least 12% or more, at least 13% or more, at least 14% or more, or at least 15% or more compared to the flowability of untreated plant seeds (i.e., seeds only). In some embodiments, the methods disclosed herein improve flowability of plant seeds from about 2% to about 20%, from about 5% to about 15%, from about 10% to about 15%, from about 11% to about 15%, from about 12 to about 15%, from about 13 to about 15%, from about 13.5% to about 15%, from about 14% to about 15%, from about 14.5% to about 15%, compared to the flowability of untreated plant seeds.

B. Methods of reducing plant seed dust comprises contacting seeds with a seed treatment composition disclosed herein. In such methods, the plant seed dust of plant seeds is reduced by at least about 30%, about 40%, about 50%, about 60%, about 65%, about 70%, about 75%, about 80%, about 85%, about 90%, or at least about 92% or more compared to the plant seed dust produced from plant seeds treated with talc-based lubricant composition. In some embodiments, the plant seed dust of plant seeds is reduced from about 30% to about 95%, from about 40% to about 95%, from about 50% to about 95%, from about 60% to about 95%, from about 65% to about 92%, from about 65% to about 90%, from about 65% to about 86%, from about 65% to about 80% from about 65% to about 78%, from about 65% to about 76%, from about 65% to about 70%, from about 70% to about 92%, from about 75% to about 92%, from about 78% to about 92%, from about 86% to about 92%, from about 89% to about 92%, or from about 70% to about 90% compared to the plant seed dust produced from seeds treated with talc-based lubricant composition, e.g., commercially available talc-based lubricant compositions containing a 80:20 talc and graphite mixture, in these methods.

C. Methods for improving plant growth and/or crop yield can also be achieved by contacting a seed treatment composition or formulation as disclosed herein, with seeds. In some embodiments, the disclosed seed treatment composition is contacted with the plant seeds in a weight ratio ranges from about 0.0001:1 to about 0.01:1

In these embodiments, seed treatment composition is in close proximity to the seed when planted so that the seed treatment composition can exert its beneficial effects in the environment where it is most needed. That is, the seed treatment composition provides an environment conducive to enhanced plant growth in the area where the effects can be localized around the desired plant. For example, the seed treatment compositions disclosed herein provides an enhanced opportunity for seed germination, subsequent plant growth, and an increase in plant nutrient availability. As such, the methods disclosed herein provides the following benefits for seeds that have been contacted with the seed treatment compositions disclosed herein: (a) increased seed plantability; (b) increased plant emergence; and/or (c) increased crop yield compared to plant seeds that are not contacted with the seed treatment composition.

D. Methods of making a seed treatment composition as disclosed herein comprising mixing a flour component with a powdered protein component to afford a homogenous flour-powdered protein mixture; contacting the homogenous flour-powdered protein mixture with a lubricant additive component to coat particles of the homogenous four-powdered protein mixture to afford the seed composition as disclosed herein. In some embodiments, the contacting step comprises heating the flour-powdered protein mixture. In some embodiments, the contacting step is carried out at an elevated temperature ranging from about 70° C. to about 85° or from about 75° C. to about 80°. In some embodiments, the mixing step comprises agitating, stirring, or tumbling. In some embodiments, the mixing step comprises hand mixing, machine grinding, or a combination thereof.

In some embodiments, the methods of making a seed treatment compositions as disclosed herein comprises mixing a dust control additive component with a lubricant component to afford a seed treatment composition as disclosed herein.

In some embodiments, the methods A and B above comprise a contacting step that may occur in a seed planter (e.g., in the seed planter box or hopper). For example, the seeds may be added to the seed planter box and then the seed treatment composition may be added to the seeds in the seed planter box. The seed treatment composition may be actively mixed with the seeds, or the seed treatment composition may be allowed to passively mix with the seeds by gravity and movement of the seeds through the box. In another embodiment, the seed treatment composition may be added to the seed planter box and then the seeds may be added to the seed treatment composition in the seed planter box.

In other embodiments, the contacting step may occur prior to adding the seeds to the seed planter box. For example, the seeds and seed treatment composition may be mixed together and packaged prior to shipping to a planting site. Alternatively, the seeds may be mixed with the seed composition at the planting site prior to adding the seed/seed treatment composition mixture to the seed planter box.

The seed planter may be a vacuum planter, a high-speed planter, an air planter, a plate planter, a plateless planter, a finger pickup planter, a row planter, a vegetable planter, or any other suitable planter. The seed treatment composition may be added manually or mechanically (e.g., a mechanized metering system) to the seed planter.

The amount of seed treatment composition disclosed herein contacted with the seeds can and will vary depending upon the seed treatment composition and the type of seeds. In general, the weight ratio of the seed treatment composition to the seeds may range from about 0.0001:1 to about 0.5:1. In certain embodiments, the weight ratio of the seed treatment composition to the seed may range from about 0.005:1 to about 0.01:1. In other embodiments, about 28.35-56.7 grams (i.e., about 1-2 ounces) of the seed treatment composition may be contacted with about 22.68 kg of soybean or corn seeds (i.e., 50 lbs.).

Contacting the seeds with the seed treatment compositions disclosed herein improves seed flowability or seed lubricity in the seed planter and prevents seed clumping or bridging in the seed planter. Seed flowability (or dry flow rate) can be measured using a funnel flow test as described in more detail below.

Particular embodiments of the subject matter described herein include:

1. A seed treatment composition comprising a grain flour, a powdered protein, and a lubricant additive, and optionally a dust control additive component.

2. The seed treatment composition of embodiment 1, wherein the grain flour is selected from the group consisting of amaranth flour, barley flour, rice flour, buckwheat flour, corn flour, millet flour, quinoa flour, rye flour, spelt flour, wheat flour, sorghum flour, oat flour, einkorn flour, emmer flour, khorasan flour, and any combination thereof.

3. The seed treatment composition of embodiment 2, wherein the grain flour is selected from the group consisting of wheat flour, corn flour, rice flour, barley flour, oat flour, and any combination thereof.

4. The seed treatment composition of any one of the preceding embodiments, wherein the powdered protein is derived from sunflower, soy, corn, peanuts, grains, eggs, or any combination thereof.

5. The seed treatment composition of any one of the preceding embodiments, wherein the lubricant additive comprises at least one lipid selected from the group consisting of a wax, a fatty alcohol, a fatty acid, and any combination and/or ester thereof.

6. The seed treatment composition of embodiment 5, wherein the wax is selected from the group of soft and pliable waxes consisting of beeswax, carnauba wax, sumac wax, paraffin wax, sunflower wax, rice bran wax, candelilla wax, ceresin wax, fumei wax, ozokerite wax, emulsifying wax, microcrystalline wax, and a combination thereof.

7. The seed treatment composition of embodiment 5, wherein the fatty alcohol is selected from the group consisting of lauryl alcohol (1-dodecanol), myristyl alcohol (1-tetradecanol), cetyl alcohol (1-hexadecanol), stearyl alcohol (1-octadecanol), and any combination and/or esters thereof.

8. The seed treatment composition of embodiment 5, wherein the fatty acid is selected from the group consisting of lauric acid (dodecanoic acid), tridecyclic acid (tridecanoic acid), myristic acid (tetradecanoic acid), pentadecyclic acid (pentadecanoic acid), palmitic acid (hexadecanoic acid), margaric acid (heptadecanoic acid), stearic acid (octadecanoic acid), nonadecylic acid (octadecanoic acid), arachidic acid (eicosanoic acid), heneicosylic acid (heneicosanoic acid), behenic acid (docosanoic acid), and any combination and/or ester thereof.

9. The seed treatment composition of any one of the preceding embodiments, wherein the optional dust control additive component is a polyanionic polymer.

10. The seed treatment composition of embodiment 9, wherein the polyanionic polymer component is naturally derived.

11. The seed treatment composition of embodiment 9, wherein the polyanionic polymer component is commercially available.

12. The seed treatment composition of any one of embodiments 9-11, wherein the polyanionic polymer component comprises a copolymer having at least two repeat units selected from the group consisting of maleic, itaconic, and sulfonate repeat units, or having maleic and olefinic repeat units.

13. The seed treatment composition of any one of the preceding embodiments, wherein the polyanionic polymer component has an average molecular weight of about 1,500-500,000 Da.

14. The seed treatment composition of any one of the preceding embodiments, wherein the grain flour is present in an amount of from about 1% to about 75% by weight based on the total weight of the seed treatment composition.

15. The seed treatment composition of any one of the preceding embodiments, wherein the powdered protein is present in an amount of from about 1% to about 75% by weight based on the total weight of the seed treatment composition.

16. The seed treatment composition of any one of the preceding embodiments, wherein the lubricant additive is present in an amount of from about 0.1% to about 20% by weight based on the total weight of the seed treatment composition.

17. The seed treatment composition of any one of the preceding embodiments, wherein the lubricant additive and the grain flour are present in a weight ratio of from about 1:20 to about 1:5.

18. The seed treatment composition of any one of the preceding embodiments, wherein the grain flour is present in an amount of from about 40% to about 70% by weight, the powdered protein is present in an amount of from about 20% to about 50% by weight, and the lubricant additive is present in an amount of from about 1% to about 10% by weight based on the total weight of the seed treatment composition.

19. A seed treatment formulation comprising the seed treatment composition of any one of the preceding embodiments and at least one material selected from inert materials, inactive agents, and/or solid lubrication materials.

20. The seed treatment formulation of embodiment 19, wherein the solid lubrication material is selected from the group consisting of molybdenum disulfide (MoS2), polytetrafluoroethylene (PTFE; teflon), graphite, boron nitride, calcium fluoride, cerium fluoride, tungsten disulfide, and a combination thereof

21. The seed treatment composition or formulation of any one of the preceding embodiments, wherein the seed treatment composition or formulation is free of talc.

22. An agricultural seed treatment composition comprising a seed treatment composition or formulation of any one of the preceding embodiments and at least one additional active agent selected from the group consisting of micronutrients, macronutrients, biostimulants, biological agents, pesticides, fertilizer, or a combination thereof.

23. The seed treatment composition of any one of the preceding embodiments, wherein the composition improves flowability of plants seeds by at least 10% compared to the flowability of untreated plant seeds.

24. The seed treatment composition of any one of the preceding embodiments, wherein the composition improves flowability of plant seeds by at least 4% compared to the flowability of plant seeds treated with a commercial tale-based lubricant composition.

25. The seed treatment composition of any one of the preceding embodiments, wherein the composition reduces formation of plant seed dust of plant seeds by at least about 40% compared to the plant dust seed produced from plant seeds treated with commercial talc-based lubricant composition.

26. A method of reducing the formation of plant seed dust and/or increasing plant seed flowability, the method comprising contacting plant seeds with the seed treatment composition of any one of the preceding embodiments.

27. The method of embodiment 26, wherein the contacting occurs in a seed planter box.

28. The method of embodiment 26 or 27, wherein the contacting occurs prior to adding the plant seeds to a seed planter box.

29. The method of any one of embodiments 26-28, wherein the contacting step comprises agitating, spraying, or tumbling.

30. The method of any one of the preceding embodiments, wherein the seed treatment composition is contacted with the plants seeds in a weight ratio of from about 0.0001:1 to about 0.01:1.

31. The method of any one of the preceding embodiments, wherein the plant seeds are selected from the group consisting of grain plant seeds, legume plant seeds, cereal plant seeds, grass plant seeds, vegetable plant seeds, oil seeds, cotton seeds, and any combination thereof.

32. The method of any one of the preceding embodiments, wherein the plant seed is a legume seed selected from chickpeas, peanuts, black beans, green peas, lima beans, kidney beans, black-eyed peas, navy beans, great northern beans, pinto beans, soybeans, lentils, adzuki beans, lupins, alfalfa, and a combination thereof.

33. The method of any one of the preceding embodiments, wherein the formation of plant seed dust is reduced by at least about 400 compared to the plant seed dust produced from commercial talc-based lubricant compositions.

34. The method of any one of the preceding embodiments, wherein the plant seed flowability was increased by at least 5% compared to the plant seed flowability exhibited by commercial talc-based lubricant compositions.

35. The method of any one of the preceding embodiments, wherein the plant seed flowability was increased by at least 10% compared to the plant seed flowability exhibited by untreated plant seeds.

36. The method of any one of the preceding embodiments, wherein the plant seeds contacted with the seed treatment composition of any one of the preceding embodiments has at least one or more of: (a) increased seed plantability; (b) increased plant emergence; and/or (c) increased crop yield compared to plant seeds that are not contacted with the seed treatment composition.

37. The method of any one of the preceding embodiments, wherein the plant seeds contacted with the seed treatment composition of any one of the preceding embodiments has at least one or more of: (a) increased seed plantability; (b) increased plant emergence; and/or (c) increased crop yield compared to plant seeds that have been contacted with a commercially available seed treatment composition.

38. A method of making the seed composition of embodiment 1, the method comprising:
mixing a grain flour with a powdered protein to afford a homogenous powdered grain flour-protein mixture;
contacting the homogenous powdered grain flour-protein mixture with a lubricant additive to coat particles of the homogenous powdered grain flour-protein mixture to afford the seed composition of embodiment 1.

39. The method of embodiment 38, wherein the contacting step comprises heating the homogenous powdered grain flour-protein mixture and the lubricant additive.

40. The method of embodiments 38 or 39, wherein the mixing step comprises agitating, stirring, or tumbling.

41. The method of any one embodiment from 38-40, wherein the grain flour is selected from the group consisting of amaranth flour, barley flour, rice flour, buckwheat flour, corn flour, millet flour, quinoa flour, rye flour, spelt flour, wheat flour, sorghum flour, oat flour, einkorn flour, emmer flour, khorasan flour, and any combination thereof.

42. The method of any one embodiment from 38-41, wherein the powdered protein is derived from sunflower, soy, corn, peanuts, grains, eggs, or any combination thereof.

43. The method of any one embodiment from 38-41, wherein the lubricant additive comprises at least one lipid selected from the group consisting of an emulsifying wax, a fatty alcohol, a fatty acid, and any combination and/or ester thereof.

### EXAMPLES

### Example 1: Dust Generation Measurements of Experimental Blends 1-4

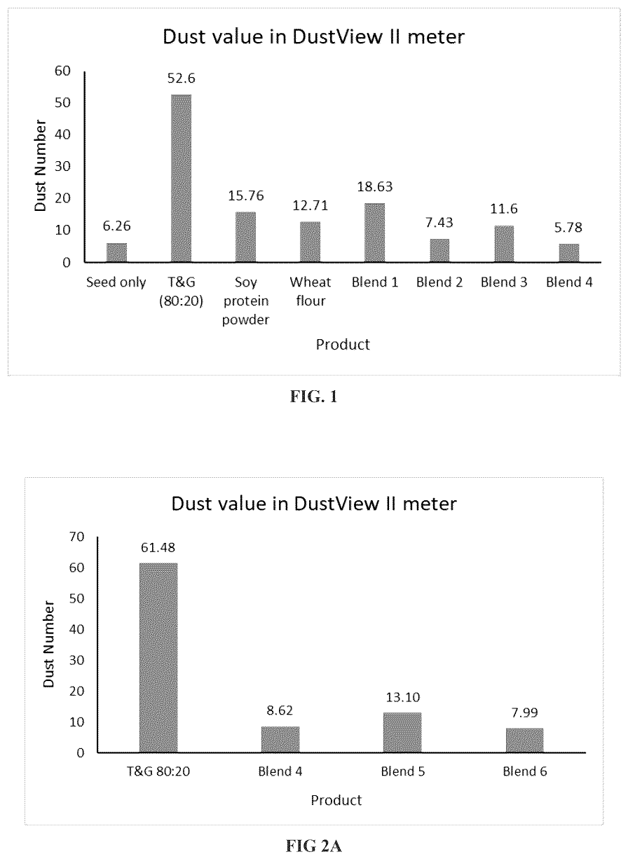

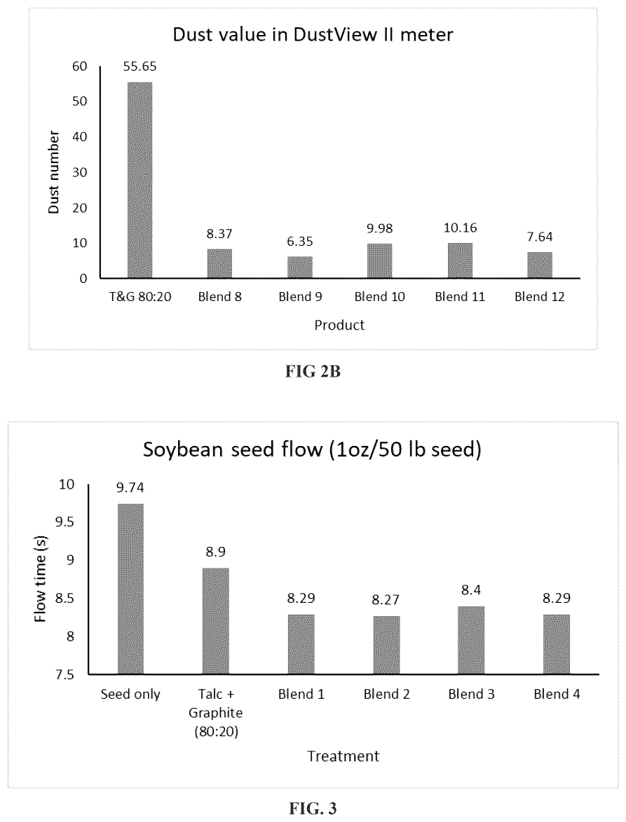

75 g of seeds (untreated) was mixed with 1 g of product and the dust generation was measured in a dust meter (Palas DustView II, Karlsruhe, Germany). The Results in FIG. 1 show that a traditional blend of talc and graphite (80:20 ratio, w/w) mixed with soybean seeds generated a very high dust (dust number 52.6), whereas the dust numbers from the ingredients soy protein powder and wheat flour were 15.76 and 12.71, respectively. Dust generation from experimental blends 1-4 was reduced up to 89% compared to commercial talc-based lubricant. Similarly, the Results in FIG. 2 show that the dust generation from the experimental blends 4, 5, and 6 was reduced up to 87% compared to the 80:20 blend of talc and graphite mixed with corn seeds.

### Example 2: Seed Flowability Measurements of Experimental Blends 1-4

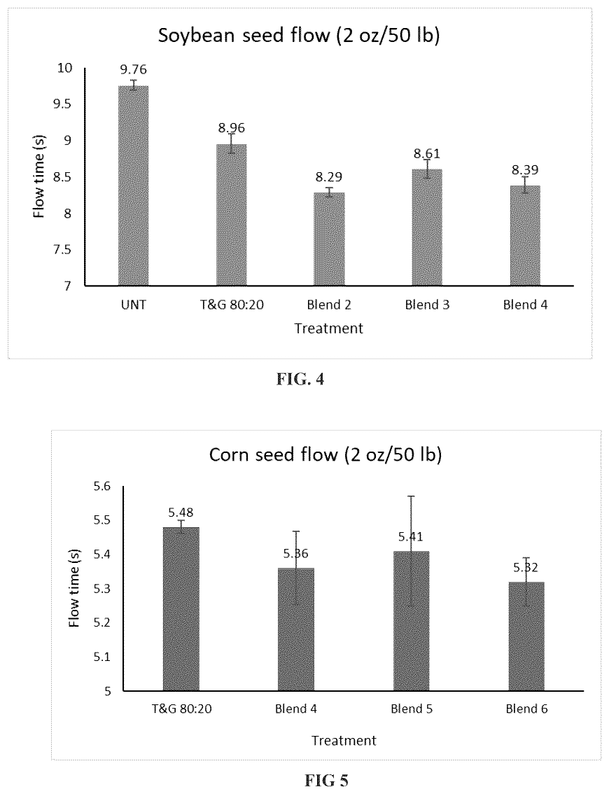

Dry soybean seed (800 g) was treated with 1 or 2 g of the product (1 g product/800 g seed is equivalent to 1 oz/50 lb) and ran through a tapered funnel. The time to flow the seeds was recorded. The funnel dimension was as follows: height=14.3 cm, aperture diameter=2.3 cm, diameter at tapered point=3.2 cm, upper diameter=19.0 cm. The results in FIGS. 3, 4, and 5 showed that the seed flowability from the blends 1-4 increased up to 15.5% compared to untreated control, and up to 7.1% compared to a talc-based lubricant.

### Example 3: Caking Measurements of Experimental Blend at High Humidity

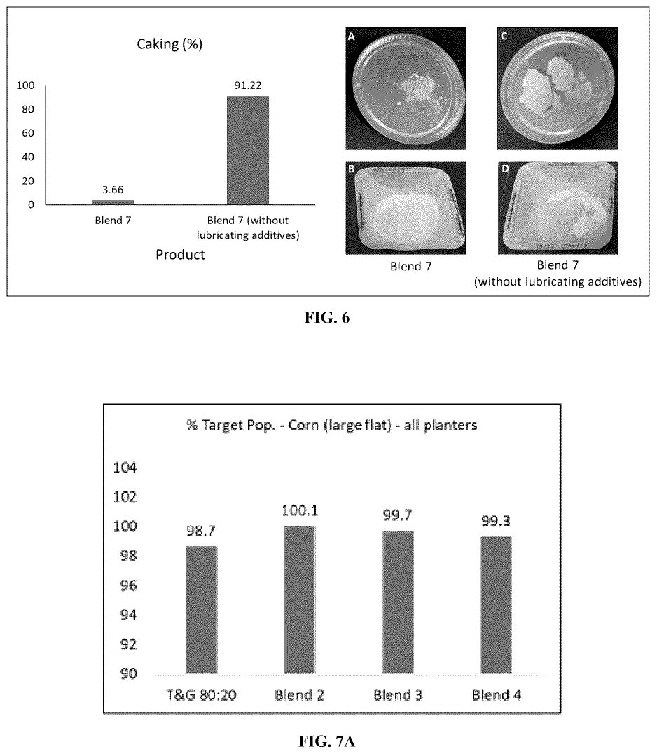

Caking was determined by storing 5 g product at 95% RH for 24 hours followed by air drying. The air dried product was gently sieved through a 35-mesh sieve. The unsieved material was considered a cake. The results in FIG. 6 showed that caking of the Experimental Blend 7 (wheat flour+soy protein powder+lubricant additive) was reduced by 95.6% compared to the same Blend without the lubricant additives.

### Example 4: Plantability Measurements of Experimental Blends

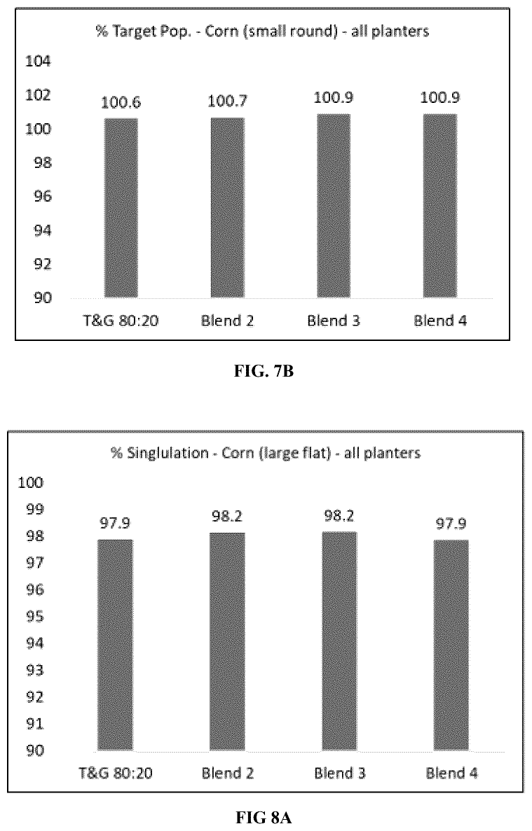

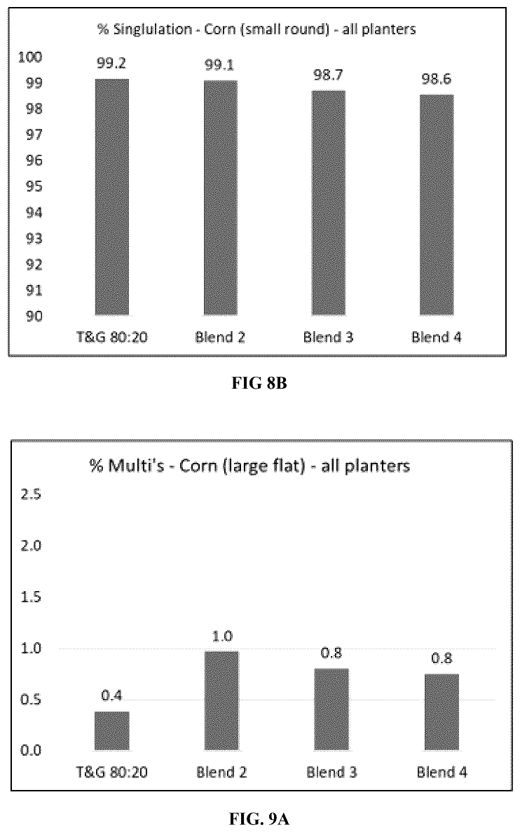

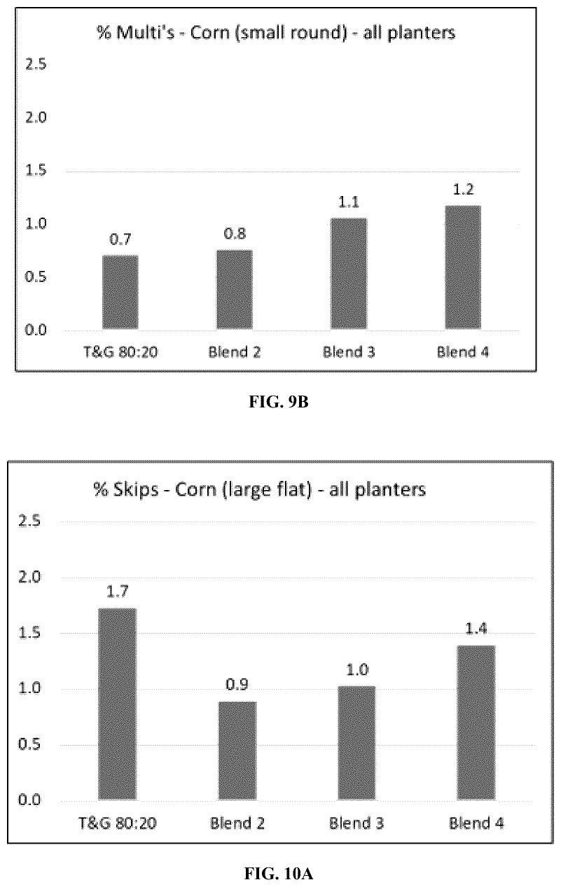

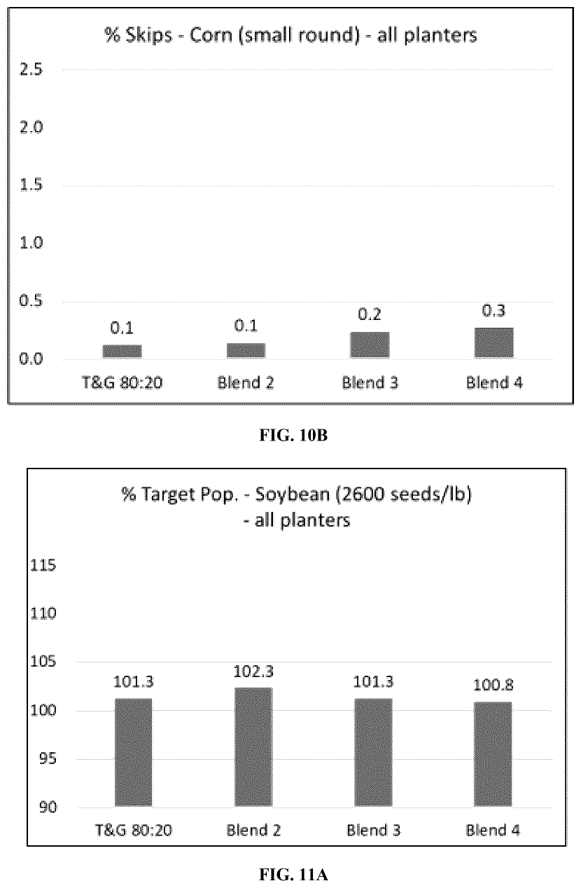

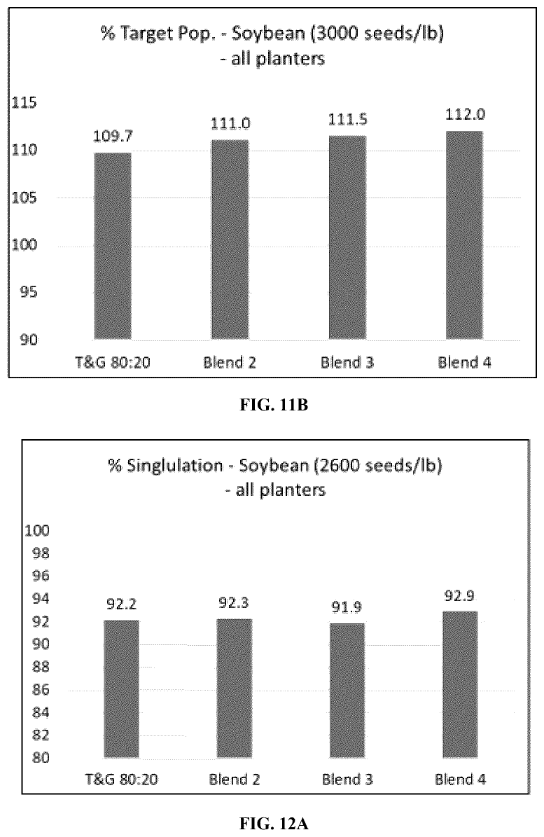

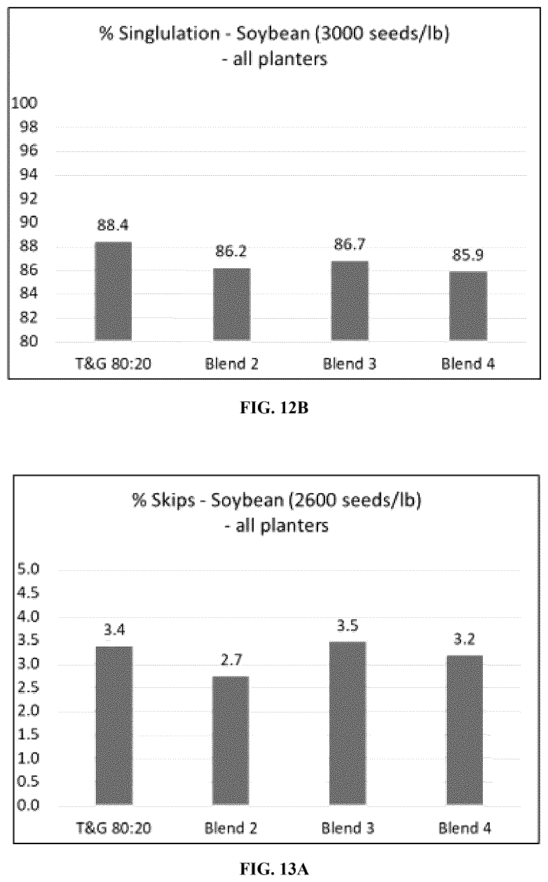

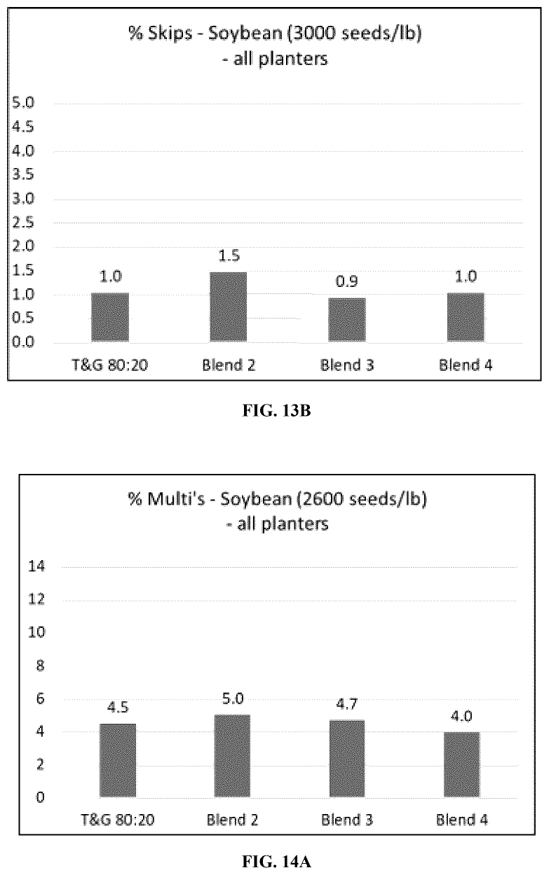

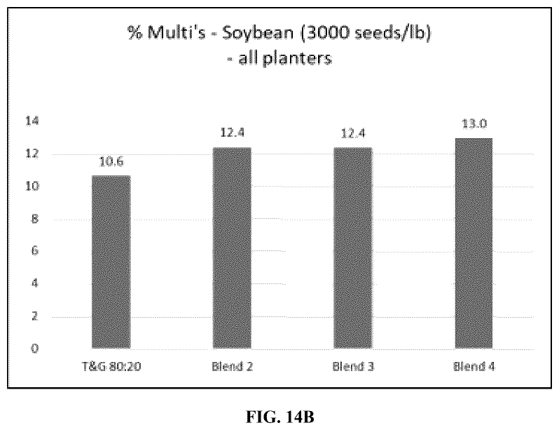

Percent target population, percent singulation, percent multi's, and percent skips of corn and soybean seeds were measured in following three planters. John Deere E-Set, Case IH Vacuum, and Kinze Finger Pick Up. Speeds of all planters was set at 5 mph for corn, while the speeds of three planters for soybean seed were 5, 1.5, and 2.2 mph, respectively. Target seed drop were 33,000/acre for corn and 160,000/acre for soybean. The Results in FIGS. 7A-14B show that % target population (the number, in %, of desired seeds that were planted in a manner that is consistent with the planter specification). % singulation (the percentage of single distributed seeds spaced and planted in a manner that is consistent with the planter specification), % multi's (the percentage of multiple planted seeds), and % skips (the percentage of seeds that were not planted in a manner that is consistent with the planter specification) of the corn and soy seeds treated with experimental blends 2, 3 and 4 were similar or better than a traditional blend of talc and graphite (80:20, w/w).

1. A seed treatment composition comprising a grain flour, a powdered protein, and a lubricant additive, and optionally a dust control additive component, wherein
the powdered protein is derived from sunflower, soy, corn, peanuts, grains, eggs, or any combination thereof;
the grain flour is selected from the group consisting of amaranth flour, barley flour, rice flour, buckwheat flour, corn flour, millet flour, quinoa flour, rye flour, spelt flour, wheat flour, sorghum flour, oat flour, einkorn flour, emmer flour, khorasan flour, and any combination thereof; and
the lubricant additive comprises at least one lipid selected from the group consisting of a wax, a fatty alcohol, a fatty acid, and any combination and/or ester thereof.

2. (canceled)

3. (canceled)

4. (canceled)

5. (canceled)

6. The seed treatment composition of claim 1, wherein the wax is selected from the group of soft and pliable waxes consisting of beeswax, carnauba wax, sumac wax, paraffin wax, sunflower wax, rice bran wax, candelilla wax, ceresin wax, fumei wax, ozokerite wax, emulsifying wax, microcrystalline wax, and a combination thereof.

7. (canceled)

8. The seed treatment composition of claim 1, wherein the fatty alcohol is selected from the group consisting of lauryl alcohol (1-dodecanol), myristyl alcohol (1-tetradecanol), cetyl alcohol (1-hexadecanol), stearyl alcohol (1-octadecanol), and any combination and/or esters thereof; and/or
wherein the fatty acid is selected from the group consisting of lauric acid (dodecanoic acid), tridecyclic acid (tridecanoic acid), myristic acid (tetradecanoic acid), pentadecyclic acid (pentadecanoic acid), palmitic acid (hexadecanoic acid), margaric acid (heptadecanoic acid), stearic acid (octadecanoic acid), nonadecylic acid (octadecanoic acid), arachidic acid (eicosanoic acid), heneicosylic acid (heneicosanoic acid), behenic acid (docosanoic acid), and any combination and/or ester thereof.

9. The seed treatment composition of claim 1, wherein the optional dust control additive component is a polyanionic polymer, wherein the polyanionic polymer component comprises a copolymer having at least two repeat units selected from the group consisting of maleic, itaconic, and sulfonate repeat units, or having maleic and olefinic repeat units.

10. (canceled)

11. (canceled)

12. (canceled)

13. (canceled)

14. (canceled)

15. (canceled)

16. (canceled)

17. The seed treatment composition of claim 1, wherein the lubricant additive and the grain flour are present in a weight ratio of from about 1:20 to about 1:5.

18. The seed treatment composition of claim 1, wherein the grain flour is present in an amount of from about 40% to about 70% by weight, the powdered protein is present in an amount of from about 20% to about 50% by weight, and the lubricant additive is present in an amount of from about 1% to about 10% by weight based on the total weight of the seed treatment composition.

19. A seed treatment formulation comprising the seed treatment composition of claim 1 and at least one material selected from inert materials, inactive agents, and/or solid lubrication materials.

20. The seed treatment formulation of claim 19, wherein the solid lubrication material is selected from the group consisting of molybdenum disulfide (MoS2), polytetrafluoroethylene (PTFE; teflon), graphite, boron nitride, calcium fluoride, cerium fluoride, tungsten disulfide, and a combination thereof.

21. The seed treatment composition of claim 1, wherein the seed treatment composition is free of talc.

22. An agricultural seed treatment composition comprising a seed treatment composition of claim 1 and at least one additional active agent selected from the group consisting of micronutrients, macronutrients, biostimulants, biological agents, pesticides, fertilizer, or a combination thereof.

23. The seed treatment composition of claim 1, wherein the composition improves flowability of plants seeds by at least 10% compared to the flowability of untreated plant seeds; and/or improves flowability of plant seeds by at least 4% compared to the flowability of plant seeds treated with a commercial talc-based lubricant composition; and/or reduces formation of plant seed dust of plant seeds by at least about 40% compared to the plant dust seed produced from plant seeds treated with commercial talc-based lubricant composition.

24. (canceled)

25. (canceled)

26. A method of reducing the formation of plant seed dust and/or increasing plant seed flowability, the method comprising contacting plant seeds with the seed treatment composition of claim 1.

27. The method of claim 26, wherein the contacting occurs in a seed planter box.

28. The method of claim 26, wherein the contacting occurs prior to adding the plant seeds to a seed planter box.

29. (canceled)

30. (canceled)

31. The method of claim 26, wherein the plant seeds are selected from the group consisting of grain plant seeds, legume plant seeds, cereal plant seeds, grass plant seeds, vegetable plant seeds, oil seeds, cotton seeds, and any combination thereof.

32. The method of claim 26, wherein the plant seed is a legume seed selected from chickpeas, peanuts, black beans, green peas, lima beans, kidney beans, black-eyed peas, navy beans, great northern beans, pinto beans, soybeans, lentils, adzuki beans, lupins, alfalfa, and a combination thereof.

33. The method of claim 26, wherein the formation of plant seed dust is reduced by at least about 40% compared to the plant seed dust produced from commercial talc-based lubricant compositions.

34. The method of claim 26, wherein the plant seed flowability was increased by at least 5% compared to the plant seed flowability exhibited by commercial talc-based lubricant compositions; and/or the plant seed flowability was increased by at least 10% compared to the plant seed flowability exhibited by untreated plant seeds.

35. (canceled)

36. The method of claim 26, wherein the plant seeds contacted with the seed treatment composition of any one of the preceding claims has at least one or more of: (a) increased seed plantability; (b) increased plant emergence; and/or (c) increased crop yield compared to plant seeds that are either not contacted with the seed treatment composition or have been contacted with a commercially available seed treatment composition.

37. (canceled)

38. A method of making the seed composition of claim 1, the method comprising:
mixing a grain flour with a powdered protein to afford a homogenous powdered grain flour-protein mixture;
contacting the homogenous powdered grain flour-protein mixture with a lubricant additive to coat particles of the homogenous powdered grain flour-protein mixture to afford the seed composition of claim 1.

39. The method of claim 38, wherein the contacting step comprises heating the homogenous powdered grain flour-protein mixture and the lubricant additive.

40. (canceled)

41. The method of claim 38, wherein the grain flour is selected from the group consisting of amaranth flour, barley flour, rice flour, buckwheat flour, corn flour, millet flour, quinoa flour, rye flour, spelt flour, wheat flour, sorghum flour, oat flour, einkorn flour, emmer flour, khorasan flour, and any combination thereof; and/or the powdered protein is derived from sunflower, soy, corn, peanuts, grains, eggs, or any combination thereof; and/or the lubricant additive comprises at least one lipid selected from the group consisting of an emulsifying wax, a fatty alcohol, a fatty acid, and any combination and/or ester thereof.

42. (canceled)

43. (canceled)
